(19) United States
(12) Patent Application Publication
(10) Pub. No.: US 2015/0199124 A1
(43) Pub. Date: Jul. 16, 2015

(54) INFORMATION PROCESSING APPARATUS, INFORMATION PROCESSING PROGRAM, AND INFORMATION PROCESSING METHOD

(71) Applicant: Konica Minolta Inc., Tokyo (JP)

(72) Inventors: Kazuhisa KISHIMOTO, Tokyo (JP); Tetsuhiro SHIBATA, Nishi-ku (JP); Keiichiro HYODO, Tokyo (JP); Masayuki INOUE, Tokyo (JP)

(21) Appl. No.: 14/586,030

(22) Filed: Dec. 30, 2014

(30) Foreign Application Priority Data
Jan. 14, 2014 (JP) 2014-004032

(51) Int. Cl. G06F 3/0488; G06F 17/24; G06F 17/21

(52) U.S. Cl. CPC G06F 3/04883; G06F 17/211; G06F 17/241

(57) ABSTRACT

An information processing apparatus includes: a display unit; an input unit; and a control unit, wherein the control unit displays a new second input page on the display unit when an input for paging in a first direction is performed while a first or last page of a first input page in which a handwriting input is performed is displayed, the second input page is not left and the first input page is set as a first or last input page when an input for paging in a second direction is performed while no handwriting input is performed in the second input page displayed, and the second input page in which a handwriting input is performed is left when the input for paging in the second direction is performed while the handwriting input is performed in the second input page displayed.

The entire disclosure of Japanese Patent Application No. 2014-004032 filed on Jan. 14, 2014 including description, claims, drawings, and abstract are incorporated herein by reference in its entirety.

### BACKGROUND OF THE INVENTION

1. Field of the Invention

The present invention relates to an information processing apparatus, an information processing program, and an information processing method.

2. Description of the Related Art

In the related art, in a word processor application or in a drawing application, there is a case where a blank part to input a character or an image becomes insufficient in a page currently displayed or a case where a user desires to input a character or an image in a new page. In such a case, basically, a new page is automatically generated when information exceeding an amount of information which can be put in one page is input or a new page is generated when a page-break input is performed manually.

As an example of the above technique, in JP 6-113060 A, an information processing apparatus in which a new blank page is added automatically when an input for paging backward is performed has been disclosed.

However, in an information processing apparatus disclosed in JP 6-113060 A, a new blank page is added each time an input for paging backward is performed. Thus, in a case where an unnecessary blank page is generated due to an operational mistake or in a case where a blank page added intentionally becomes unnecessary, the useless blank page remains when the blank page is left as it is.

### SUMMARY OF THE INVENTION

Thus, an object of the present invention is to provide an information processing apparatus, an information processing program, and an information processing method which can control remaining of a useless page.

To achieve the abovementioned object, according to an aspect, an information processing apparatus in which a handwriting input can be performed reflecting one aspect of the present invention comprises a display unit, an input unit, and a control unit. The display unit displays an input page in which a handwriting input can be performed. The input unit includes a paging unit to perform paging of an input page in forward and backward directions. Also, the input unit receives an input from a user, the input including a handwriting input into an input page. Based on the input from the user which input is received through the input unit, the control unit controls displaying on the display unit. Also, when an input for paging in a first direction is performed through the paging unit while a first or last page of a first input page in which a handwriting input is performed is displayed on the display unit, the control unit displays a new second input page on the display unit. The first direction is a direction which is one of the forward and backward directions and in which no new input page exists. Also, when an input for paging in a second direction is performed through the paging unit while no handwriting input is performed in the second input page displayed on the display unit, the control unit does not leave the second input page displayed on the display unit and sets the first input page as a first or last input page. The second direction is an opposite direction of the first direction. Moreover, the input for paging in the second direction is performed while a handwriting input is performed in a new input page displayed on the display unit, the control unit leaves the second input page in which the handwriting input is performed.

Here, for example, when a second input page is displayed on the display unit, the forward and backward directions are a direction of performing paging to a first page and a direction of performing paging to a third page, respectively. Also, the state in which a handwriting input is performed means a state in which a certain drawing such as a character or a figure is performed.

In the information processing apparatus of Item. 1, a second input page is an input page newly displayed on the display unit when the paging in the first direction is performed while the first or last page of the first input page in which the handwriting input is performed is displayed. Also, the second input page is an input page which is not left when the paging in the second direction is performed while no handwriting input is performed. Thus, even when a second input page is generated due to erroneous operation or when an intentionally-generated second input page becomes unnecessary, a user can easily delete a new second input page only by performing an input into the paging unit. Thus, remaining of a useless blank input page can be controlled.

The information processing apparatus of Item. 2 is the information processing apparatus of Item. 1, wherein the control unit preferably counts the second input page, in which the handwriting input is performed, as one page.

Here, in the information processing apparatus of Item. 2, the second input page has an attribution to be counted as one page when a handwriting input is performed therein. In other words, the second input page is not confirmed or counted as one page until a handwriting input is performed. In such a manner, in the information processing apparatus of Item. 2, since the second input page has the above-described attribution, a user can delete the second input page only by performing paging when the second input page is not necessary. Thus, convenience for a user can be improved.

The information processing apparatus of Item. 3 is the information processing apparatus of Item. 2, wherein the display unit further preferably displays the total number of input pages. When the second input page in which the handwriting input is performed is counted as one page, the control unit preferably increases the total number of input pages displayed on the display unit.

In the information processing apparatus of Item. 3, the total number of input pages displayed on the display unit is increased. Thus, the total number of input pages can be recognized by a user at a glance.

The information processing apparatus of Item. 4 is the information processing apparatus of Item. 1, wherein the control unit preferably does not display a new input page on the display unit even when the input for paging in the first direction is performed through the paging unit while the second input page in which no handwriting input is performed is displayed on the display unit.

Here, for example, in an information processing apparatus, in which a second input page is generated by an input into a paging unit, such as what is described in the present invention, a plurality of useless input pages may be generated by erroneous operation. When a plurality of useless input pages is generated due to erroneous operation, it is necessary for a user to delete unnecessary input pages one by one. Thus, less convenience is concerned.

Thus, in the information processing apparatus of Item. 4, when the input for paging in the first direction is performed into the paging unit while no handwriting input is performed in the second input page, a new input page is not displayed on the display unit. Thus, an useless input page due to erroneous operation is prevented from being generated. Also, a plurality of useless input pages is prevented from being generated previously. Thus, unlike the related art, it is not necessary for a user to delete unnecessary input pages one by one and convenience is improved.

The information processing apparatus of Item. 5 is the information processing apparatus of Item. 1, wherein the control unit preferably performs, as control to display the second input page on the display unit, one of first control, second control, and third control. The first control is control to display the second input page on the display unit when the input for paging in the first direction is performed only in a case where a first input page is displayed on the display unit. The second control is control to display the second input page on the display unit when the input for paging in the first direction is performed only in a case where a last input page is displayed on the display unit. The third control is control to display the second input page on the display unit when the input for paging in the first direction is performed in both of the case where the first input page is displayed on the display unit and the case where the last input page is displayed thereon.

Here, for example, a user may set previously whether the control unit performs the first control, the second control, or the third control or the control unit itself may arbitrarily determine control to be performed by learning.

In the information processing apparatus of Item. 5, it is possible to perform display switching into a new input page according to an intention or utilization condition of a user. Thus, convenience for a user is improved.

The information processing apparatus of Item. 6 is the information processing apparatus of Item. 1, wherein in a case where there is a plurality of documents including the input page, the control unit preferably displays the second input page on the display unit when the input for paging in the first direction is performed through the paging unit while a first input page in a document which is first in display order among the plurality of documents or a last input page in a document which is last in display order among the plurality of documents is displayed.

Here, for example, in a case where the information processing apparatus includes a configuration to display a plurality of documents serially (for example, in display order) on the display unit, a first input page in a document which is the first in the display order is set as a first input page in the plurality of documents and a last input page in a document which is the last in the display order is set as a last input page in the plurality of documents. In such a manner, even in the information processing apparatus of Item. 6 which apparatus includes a configuration to display a plurality of documents serially on the display unit, it is possible to display the second input page on the display unit easily.

To achieve the abovementioned object, according to an aspect, a non-transitory recording medium storing a computer readable program which processes information reflecting one aspect of the present invention causes an information processing apparatus, in which a handwriting input can be performed and which includes a display unit configured to display an input page on which a handwriting input can be performed and an input unit which includes a paging unit configured to perform paging of the input page in forward and backward directions and which is configured to receive an input from a user which input includes a handwriting input into the input page, to make the display unit display a new second input page on the display unit when an input for paging in a first direction, which is one of the forward and backward directions and in which no input page exists, is performed through the paging unit while a first page or last page of a first input page in which a handwriting input is performed is displayed on the display unit, not to leave the second input page and to set the first input page as a first or last input page when an input for paging in a second direction which is an opposite direction of the first direction is performed through the paging unit while no handwriting input is performed in the second input page displayed on the display unit, and to leave the second input page in which a handwriting input is performed when the input for paging in the second direction is performed while the handwriting input is performed in the second input page displayed on the display unit.

Since the non-transitory recording medium storing a computer readable program which processes information of Item. 7 is executed by the information processing apparatus, even when a second input page is generated due to erroneous operation or when an intentionally-generated second input page becomes unnecessary, a user can easily delete a new second input page only by performing an input into the paging unit. Thus, remaining of a useless blank input page can be controlled.

The non-transitory recording medium storing a computer readable program which processes information of Item. 8 is the non-transitory recording medium storing a computer readable program which processes information of Item. 7, wherein the control unit preferably counts the second input page, in which the handwriting input is performed, as one page.

Here, in the non-transitory recording medium storing a computer readable program which processes information of Item. 8, the second input page has an attribution to be counted as one page when a handwriting input is performed. In other words, the second input page is not confirmed or counted as one page until a handwriting input is performed. In such a manner, in the non-transitory recording medium storing a computer readable program which processes information of Item. 8, since the second input page has the above-described attribution, a user can delete the second input page only by performing paging when the second input page is not necessary. Thus, convenience for a user can be improved.

The non-transitory recording medium storing a computer readable program which processes information of Item. 9 is the non-transitory recording medium storing a computer readable program which processes information of Item. 8, wherein a total number of input pages is preferably further displayed on the display unit, and the total number of input pages displayed on the display unit is preferably increased when the second input page in which the handwriting input is performed is counted as one page.

In the non-transitory recording medium storing a computer readable program which processes information of Item. 9, the total number of input pages displayed on the display unit is increased. Thus, the total number of input pages can be recognized by a user at a glance.

The non-transitory recording medium storing a computer readable program which processes information of Item. 10 is the non-transitory recording medium storing a computer readable program which processes information of Item. 7, wherein a new input page is not preferably displayed on the display unit even when the input for paging in the first direction is performed through the paging unit while the second input page in which no handwriting input is performed is displayed on the display unit.

Here, for example, in an information processing apparatus, in which a second input page is generated by an input into a paging unit, such as what is described in the present invention, a plurality of useless input pages may be generated by erroneous operation. When a plurality of useless input pages is generated due to erroneous operation, it is necessary for a user to delete unnecessary input pages one by one. Thus, less convenience is concerned.

Thus, in the non-transitory recording medium storing a computer readable program which processes information of Item. 10, when the input for paging in the first direction is performed into the paging unit while no handwriting input is performed in the second input page, a new input page is not displayed on the display unit. Thus, an useless input page due to erroneous operation is prevented from being generated. Also, a plurality of useless input pages is prevented from being generated previously. Thus, unlike the related art, it is not necessary for a user to delete unnecessary input pages one by one and convenience is improved.

The non-transitory recording medium storing a computer readable program which processes information of Item. 11 is the non-transitory recording medium storing a computer readable program which processes information of Item. 7, wherein as control to display the second input page on the display unit, one of the following kinds of control is preferably performed: first control to display the second input page on the display unit when the input for paging in the first direction is performed only in a case where the first page of the first input page is displayed on the display unit; second control to display the second input page on the display unit when the input for paging in the first direction is performed only in a case where the last page of the first input page is displayed on the display unit; and third control to display the second input page on the display unit when the input for paging in the first direction is performed in both of the case where the first page of the first input page is displayed on the display unit and the case where the last page of the first input page is displayed thereon.

Here, for example, a user may set previously whether the control unit performs the first control, the second control, or the third control or the control unit itself may arbitrarily determine control to be performed by learning.

In the information processing apparatus of Item. 11, it is possible to perform display switching into a new input page according to an intention or utilization condition of a user. Thus, convenience for a user is improved.

The non-transitory recording medium storing a computer readable program which processes information of Item. 12 is the non-transitory recording medium storing a computer readable program which processes information of Item. 7, wherein in a case where there is a plurality of documents including the input page, the second input page is preferably displayed on the display unit when the input for paging in the first direction is performed through the paging unit while a first input page in a document which is first in display order among the plurality of documents or a last input page in a document which is last in the display order among the plurality of documents is displayed.

Here, for example, in a case where the information processing apparatus includes a configuration to display a plurality of documents serially (for example, in display order) on the display unit, a first input page in a document which is the first in the display order is set as a first input page in the plurality of documents and a last input page in a document which is the last in the display order is set as a last input page in the plurality of documents. In such a manner, even in the non-transitory recording medium storing a computer readable program which processes information of Item. 12 which program includes a configuration to display a plurality of documents serially on the display unit, it is possible to display the second input page on the display unit easily.

To achieve the abovementioned object, according to an aspect, an information processing method in an information processing apparatus in which a handwriting input can be performed and which includes a display unit configured to display an input page in which a handwriting input can be performed, and an input unit which includes a paging unit configured to perform paging of the input page in forward and backward directions and which is configured to receive an input from a user which input includes the handwriting input into the input page, the method reflecting one aspect of the present invention comprises: displaying a new second input page on the display unit when an input for paging in a first direction, which is one of the forward and backward directions and in which no input page exists, is performed through the paging unit while a first or last page of a first input page in which a handwriting input is performed is displayed on the display unit; not leaving the second input page and setting the first input page as a first or last input page when an input for paging in a second direction which is an opposite direction of the first direction is performed through the paging unit while no handwriting input is performed in the second input page displayed on the display unit; and leaving the second input page in which a handwriting input is performed when the input for paging in the second direction is performed while the handwriting input is performed in the second input page displayed on the display unit.

Since the information processing method of Item. 13 is executed by the information processing apparatus, even when a second input page is generated due to erroneous operation or when an intentionally-generated second input page becomes unnecessary, a user can easily delete a new second input page only by performing an input into the paging unit. Thus, remaining of a useless blank input page can be controlled.

The information processing method of Item. 14 is the information processing method of Item. 13, wherein the control unit preferably counts the second input page, in which the handwriting input is performed, as one page.

Here, in the information processing method of Item. 14, the second input page has an attribution to be counted as one page when a handwriting input is performed. In other words, the second input page is not confirmed or counted as one page until a handwriting input is performed. In such a manner, in the information processing method of Item. 14, since the second input page has the above-described attribution, a user can delete the second input page only by performing paging when the second input page is not necessary. Thus, convenience for a user can be improved.

The information processing method of Item. 15 is the information processing method of Item. 14, wherein a total number of input pages is preferably further displayed on the display unit, and the total number of input pages displayed on the display unit is preferably increased when the second input page in which the handwriting input is performed is counted as one page.

In the information processing method of Item. 15, the total number of input pages displayed on the display unit is increased. Thus, the total number of input pages can be recognized by a user at a glance.

The information processing method of Item. 16 is the information processing method of Item. 13, wherein a new input page is not preferably displayed on the display unit even when the input for paging in the first direction is performed through the paging unit while the second input page in which no handwriting input is performed is displayed on the display unit.

Here, for example, in an information processing apparatus, in which a second input page is generated by an input into a paging unit, such as what is described in the present invention, a plurality of useless input pages may be generated by erroneous operation. When a plurality of useless input pages is generated due to erroneous operation, it is necessary for a user to delete unnecessary input pages one by one. Thus, less convenience is concerned.

Thus, in the information processing method of Item. 16, when the input for paging in the first direction is performed into the paging unit while no handwriting input is performed in the second input page, a new input page is not displayed on the display unit. Thus, an useless input page due to erroneous operation is prevented from being generated. Also, a plurality of useless input pages is prevented from being generated previously. Thus, unlike the related art, it is not necessary for a user to delete unnecessary input pages one by one and convenience is improved.

The information processing method of Item. 17 is the information processing method of Item. 13, wherein as control to display the second input page on the display unit, one of the following kinds of control is preferably performed: first control to display the second input page on the display unit when the input for paging in the first direction is performed only in a case where the first page of the first input page is displayed on the display unit; second control to display the second input page on the display unit when the input for paging in the first direction is performed only in a case where the last page of the first input page is displayed on the display unit; and third control to display the second input page on the display unit when the input for paging in the first direction is performed in both of the case where the first page of the first input page is displayed on the display unit and the case where the last page of the first input page is displayed thereon.

Here, for example, a user may set previously whether the control unit performs the first control, the second control, or the third control or the control unit itself may arbitrarily determine control to be performed by learning.

In the information processing method of Item. 17, it is possible to perform display switching into a new input page according to an intention or utilization condition of a user. Thus, convenience for a user is improved.

The information processing method of Item. 18 is the information processing method of Item. 13, wherein in a case where there is a plurality of documents including the input page, the second input page is preferably displayed on the display unit when the input for paging in the first direction is performed through the paging unit while a first input page in a document which is first in display order among the plurality of documents or a last input page in a document which is last in display order among the plurality of documents is displayed.

Here, for example, in a case where the information processing apparatus includes a configuration to display a plurality of documents serially (for example, in display order) on the display unit, a first input page in a document which is the first in the display order is set as a first input page in the plurality of documents and a last input page in a document which is the last in the display order is set as a last input page in the plurality of documents. In such a manner, even in the information processing method of Item. 18 which method includes a configuration to display a plurality of documents serially on the display unit, it is possible to display the second input page on the display unit easily.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic front view of an information processing apparatus according to a first embodiment;

FIG. 2 is a hardware configuration diagram of the information processing apparatus according to the first embodiment;

FIG. 3 is a functional configuration diagram of a storage apparatus;

FIG. 4 is a functional configuration diagram of a control apparatus;

FIG. 5 is a flowchart illustrating display control of an input page;

FIG. 6 is a schematic front view of the information processing apparatus, the view illustrating a display in a state in which a handwriting input is performed on an input page in a handwriting input mode;

FIG. 7 is a flowchart illustrating drawing control on an input page;

FIG. 8 is a flowchart illustrating page shifting control;

FIG. 9 is a flowchart illustrating control of control of paging backward;

FIG. 10A to FIG. 10C are schematic front views of the information processing apparatus, the views illustrating control of displaying the number of pages in the control of paging backward;

FIG. 11 is a flowchart illustrating control of paging forward;

FIG. 12A to FIG. 12C are schematic front views of the information processing apparatus, the views illustrating control of displaying the number of pages in the control of paging forward;

FIG. 13 is a flowchart illustrating document storing control;

FIG. 14 is a flowchart illustrating independent document storing control;

FIG. 15 is a flowchart illustrating control of performing adding to an existing document;

FIG. 16 is a flowchart illustrating control of determining a document to which adding is performed;

FIG. 17 is a functional configuration diagram of a storage apparatus in an information processing apparatus according to a modification 1A;

FIG. 18 is a schematic front view of the information processing apparatus according to the modification 1A;

FIG. 19 is a schematic front view of an information processing apparatus according to a modification 1B;

FIG. 20 is a schematic front view of an information processing apparatus in a state in which a selection screen to determine whether to delete a first switched input page and a last switched input page is displayed on a display;

FIG. 21 is a schematic front view of an information processing apparatus according to a second embodiment;

FIG. 22 is a schematic view of an input page which view is for describing display order on a display; and

FIG. 23 is a schematic front view of the information processing apparatus according to the second embodiment, the information processing apparatus being in a state in which a setting screen to determine a document to which adding is performed is displayed on the display.

### DESCRIPTION OF THE PREFERRED EMBODIMENTS

Hereinafter, an information processing apparatus according to an embodiment of the present invention will be described with reference to the drawings. However, the scope of the invention is not limited to the illustrated examples.

### <First Embodiment> (1) Information Processing Apparatus

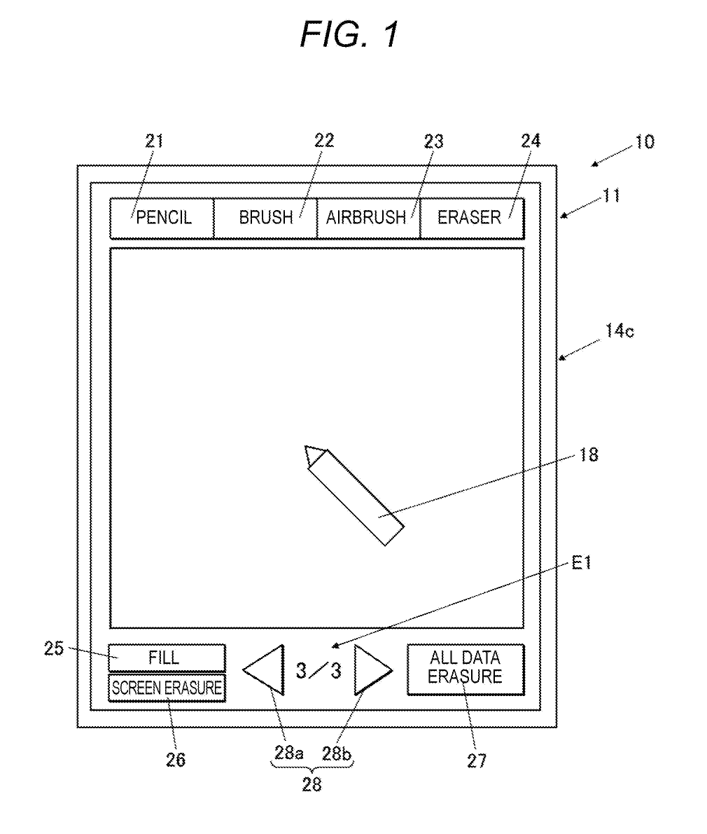

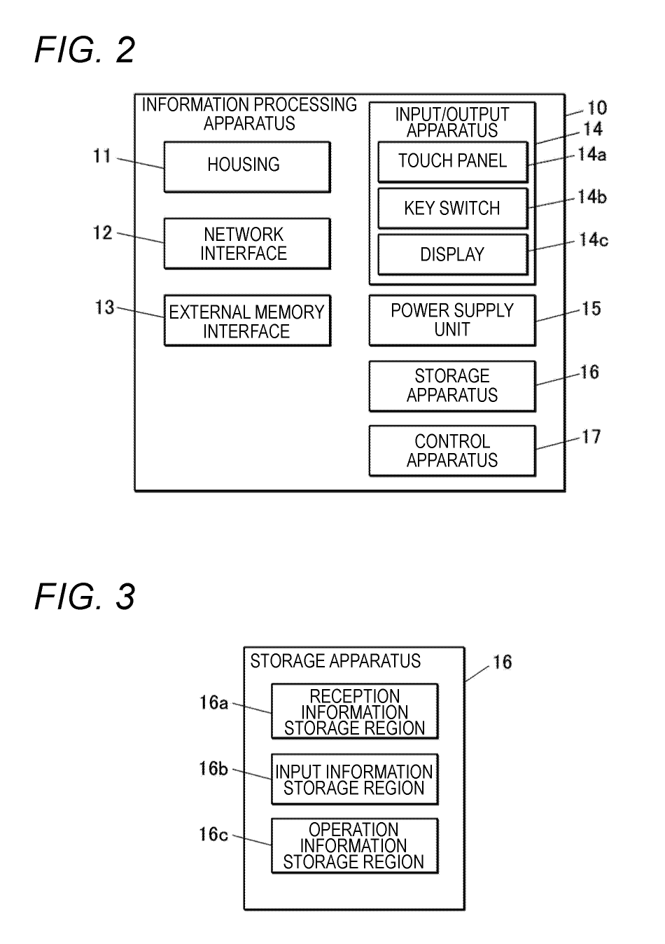

FIG. 1 is a schematic front view of an information processing apparatus 10 according to a first embodiment of the present invention. FIG. 2 is a hardware configuration diagram of the information processing apparatus 10. Note that in the following description, words indicating directions such as up, down, right, and left are used. Each of these words means a direction of when the information processing apparatus 10 in a state illustrated in FIG. 1 is seen from a front side of paper. Also, a part, which is seen from the front side of a screen (paper), of the information processing apparatus 10 in the state illustrated in FIG. 1 is called a front and a part seen from an opposite side of the screen (paper) is called a back.

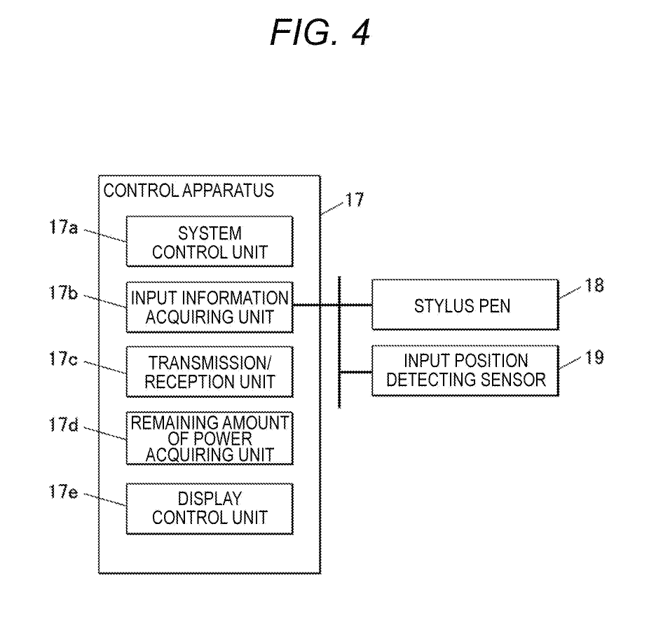

The information processing apparatus 10 is a portable apparatus on which a user can perform an handwriting input by using a stylus pen 18 (see FIG. 1 and FIG. 4) or a finger. As illustrated in FIG. 1 and FIG. 2, the information processing apparatus 10 mainly includes a housing 11, a network interface 12, an external memory interface 13, an input/output apparatus 14, a power supply unit 15, a storage apparatus 16, and a control apparatus 17. The network interface 12, the external memory interface 13, the input/output apparatus 14, the power supply unit 15, the storage apparatus 16, and the control apparatus 17 are housed in the housing 11.

(1-1) Housing

The housing 11 is a member which configures a main body of the information processing apparatus 10. The housing 11 includes a tabular shape which is elongated upward/downward and has a thin thickness in a front view.

(1-2) Network Interface

The network interface 12 functions as a communication unit to connect the information processing apparatus 10 to a network (not illustrated). The network is a network through a communication line such as a LAN or the Internet. Note that the communication line maybe either a wireless or wired line. The information processing apparatus 10 transmits/receives data to/from an external apparatus (not illustrated) through the network interface 12. The external apparatus only needs to be an apparatus which can transmit/receive data and may be, for example, a computer, a mobile phone, or an image forming apparatus.

(1-3) External Memory Interface

The external memory interface 13 includes a connection port or a connection terminal to connect an external memory (not illustrated) such as a universal serial bus (USB) memory or a secure digital memory card (SD memory card) to the information processing apparatus 10 and also includes an interface circuit to transmit/receive data to/from a connected external memory. There may be one or more external memory interfaces 13.

(1-4) Input/Output Apparatus

The input/output apparatus 14 mainly includes a touch panel 14a and a key switch 14b, each of which is an input unit to receive an input from a user, and a display 14c which is a display unit to display various kinds of information.

The touch panel 14a receives an input from a user by a contact of the stylus pen 18 or a finger of a user. The input includes not only an input performed by pressing an instruction unit (such as button 21 to 28 which will be described later) or the like to instruct various operations but also a handwriting input to draw a character, a figure, or the like. The key switch 14b includes a function to receive an instruction input of turning on/off a power supply of the information processing apparatus 10 or of system setting of the information processing apparatus 10.

Note that the key switch 14b may include not only a function to receive an input related to turning on/off a power supply of the information processing apparatus 10 or related to system setting thereof but also a function to receive an input performed on the touch panel 14a. That is, the input unit of the input/output apparatus 14 may include either the touch panel 14a or the key switch 14b as long as various inputs from a user can be received.

The display 14c includes a display surface to display various kinds of information. The display surface is arranged on a front part of the housing 11. The display 14c is arranged in such a manner as to be superimposed on a back side of the touch panel 14a. The display 14c displays various kinds of information by using an electrophoretic method. Note that the display 14c is not limited to what uses the electrophoretic method but may be a liquid crystal display, a plasma display, an organic EL display, or the like.

The display 14c displays an input page to receive a handwriting input from a user through the touch panel 14a or a button to receive an instruction input from a user through the touch panel 14a. When a user touches the button displayed on the display 14c, control processing related to the button is performed. The input page and the button displayed on the display 14c will be described later. Note that the display 14c may display an icon instead of the button.

(1-5) Power Supply Unit

The power supply unit 15 is arranged on a back side part in an inside of the housing 11 and is a unit to supply power necessary for operating various functions of the information processing apparatus 10. In the present embodiment, the power supply unit 15 includes a secondary cell such as an alkali storage battery or a lithium-ion cell but this is not the limitation. The power supply unit 15 maybe a primary cell such as a dry cell, a solar cell, or a fuel cell.

(1-6) Storage Apparatus

FIG. 3 is a functional configuration diagram of the storage apparatus 16.

The storage apparatus 16 mainly includes a RAM, a ROM, and a hard disk and stores various programs or various kinds of data. More specifically, as illustrated in FIG. 3, the storage apparatus 16 includes a reception information storage region 16a, an input information storage region 16b, and an operation information storage region 16c.

(1-6-1) Reception Information Storage Region

In the reception information storage region 16a, reception information received from an external apparatus is housed. The reception information includes document data, image data, moving image data, or the like generated in the external apparatus.

(1-6-2) Input Information Storage Region

In the input information storage region 16b, input information or the like input by a user through the touch panel 14a or the key switch 14b of the input/output apparatus 14 is housed. That is, information of an instruction input to the information processing apparatus 10 or information input by handwriting on an input page is housed.

(1-6-3) Operation Information Storage Region

In the operation information storage region 16c, operation information of the information processing apparatus 10 such as a remaining amount of power is housed. The operation information is displayed on the display 14c.

(1-7) Control Apparatus

FIG. 4 is a functional configuration diagram of the control apparatus 17.

The control apparatus 17 mainly includes a CPU and functions as a system control unit 17a, an input information acquiring unit 17b, a transmission/reception unit 17c, a remaining amount of power acquiring unit 17d, a display control unit 17e, and the like (see FIG. 4) by executing various programs stored in the storage apparatus 16.

(1-7-1) System Control Unit

The system control unit 17a gives an instruction to various function units (such as input information acquiring unit 17b, transmission/reception unit 17c, remaining amount of power acquiring unit 17d, and display control unit 17e) according to an instruction or the like from a user. The instruction from the user is given when a user touches the button displayed on the display 14c by using the stylus pen 18 or a finger.

(1-7-2) Input Information Acquiring Unit

The input information acquiring unit 17b acquires input information input by a user through the touch panel 14a or the key switch 14b of the input/output apparatus 14 and gives a notification to the system control unit 17a that there is an input from the user. Also, the input information acquiring unit 17b houses the acquired input information into the above-described input information storage region 16b.

(1-7-3) Transmission/Reception Unit

The transmission/reception unit 17c transmits/receives various kinds of information to/from an external apparatus based on an instruction from the system control unit 17a and houses the reception information received from the external apparatus into the above-described reception information storage region 16a.

(1-7-4) Remaining Amount of Power Acquiring Unit

The remaining amount of power acquiring unit 17d acquires a remaining amount of power in the power supply unit 15 at predetermined time intervals. Then, the remaining amount of power acquiring unit 17d stores the acquired remaining amount of power into the operation information storage region 16c and gives a notification to the system control unit 17a. When acquiring information of the remaining amount of power in the power supply unit 15 from the remaining amount of power acquiring unit 17d, the system control unit 17a gives an instruction to the display control unit 17e to display the acquired information of the remaining amount of power on the display 14c (not illustrated). Note that the notification of the remaining amount of power in the power supply unit 15 to a user is not limited to be performed by a display but may be performed by a sound.

(1-7-5) Display Control Unit

The display control unit 17e performs control to display various kinds of information on the display 14c based on the instruction from the system control unit 17a.

(2) Control of Information Processing Apparatus

The information processing apparatus 10 includes a handwriting input mode. In the handwriting input mode, a predetermined page included in document data, image data, or the like received from an external apparatus or document data, image data, or the like generated in the information processing apparatus 10 or read from an external memory (such as SD card or USB memory) is displayed as an input page on the display 14c or a new blank input page is displayed on the display 14c, and a handwriting input from a user is received. Here, the input page is a page which is displayed on the display 14c and to which a handwriting input of a character, a figure, or the like can be performed through the touch panel 14a.

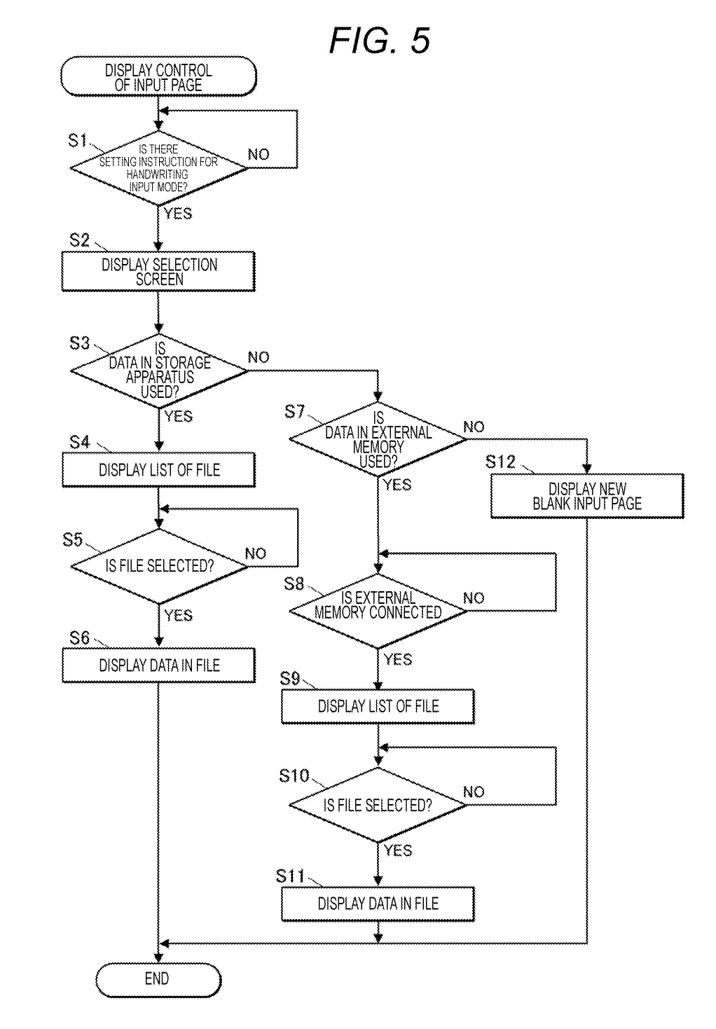

In the following, various kinds of processing in the handwriting input mode will be described with reference to FIG. 5 to FIG. 16. Note that the control apparatus 17 executes various programs stored in the storage apparatus 16, and thus, whole control, which includes control described in the following, of the information processing apparatus 10 is executed.

<Display Control of Input Page>

FIG. 5 is a flowchart illustrating display control of an input page.

In the following, display control of an input page in the handwriting input mode will be described with reference to FIG. 5.

First, in step S1, it is determined whether there is an instruction to set a handwriting input mode. The instruction to set the handwriting input mode is given when a user pushes a button for the handwriting input mode (not illustrated). When it is determined that there is the instruction to set the handwriting input mode, processing goes to step S2. On the other hand, when it is determined that there is no instruction to set the handwriting input mode, waiting is performed until the instruction to set the handwriting input mode is given.

In step S2, a selection screen for selection whether to use, as an input page displayed on the display 14c, a document or the like stored in the storage apparatus 16, a document or the like read from an external memory, or a new blank input page is displayed on the display 14c. Then, in a case where it is determined in step S3 that selection to use the document or the like stored in the storage apparatus 16 as an input page is performed on the selection screen (YES in step S3), a list of files stored in the storage apparatus 16 is displayed on the display 14c in a selectable manner (step S4). Then, when it is determined in step S5 that a predetermined file is selected (YES in step S5), a first page of data in the selected file is displayed as an input page on the display 14c (step S6). Note that here, the first page of the data in the selected file is displayed as an input page on the display 14c, but a page displayed on the display 14c is not limited thereto and may be set by a user previously or may be set by a user on a setting screen displayed at this stage. When it is determined that a predetermined file is not selected (NO in step S5), waiting is performed until selection of a file is performed.

When it is determined in step S3 that selection to use the document data or the like stored in the storage apparatus 16 as an input page is not performed (NO in step S3), it is determined in step S7 whether selection to use a document or the like read from an external memory as an input page is performed. When it is determined that selection to use the document data or the like read from the external memory as an input page is performed (YES in step S7), it is determined whether the external memory is connected to the external memory interface 13 (step S8). When it is determined that the external memory is connected to the external memory interface 13 (YES in step S8), a list of files stored in the external memory is displayed on the display 14c in a selectable manner (step S9). When it is determined that the external memory is not connected to the external memory interface 13 (NO in step S8), waiting is performed until the external memory is connected. When it is determined in step S10 that a predetermined file is selected (YES in step S10), a first page of data in the selected file is displayed as an input page on the display 14c (step S11). Note that similarly to step S6, a configuration can be changed also in step S11. When it is determined that a predetermined is not selected (NO in step S10), waiting is performed until selection of a file is performed.

When it is determined in step S7 that selection to use the document or the like read from the external memory as an input page is not performed (NO in step S7), a blank input page is displayed on the display 14c (step S12).

<Drawing Control on Input Page>

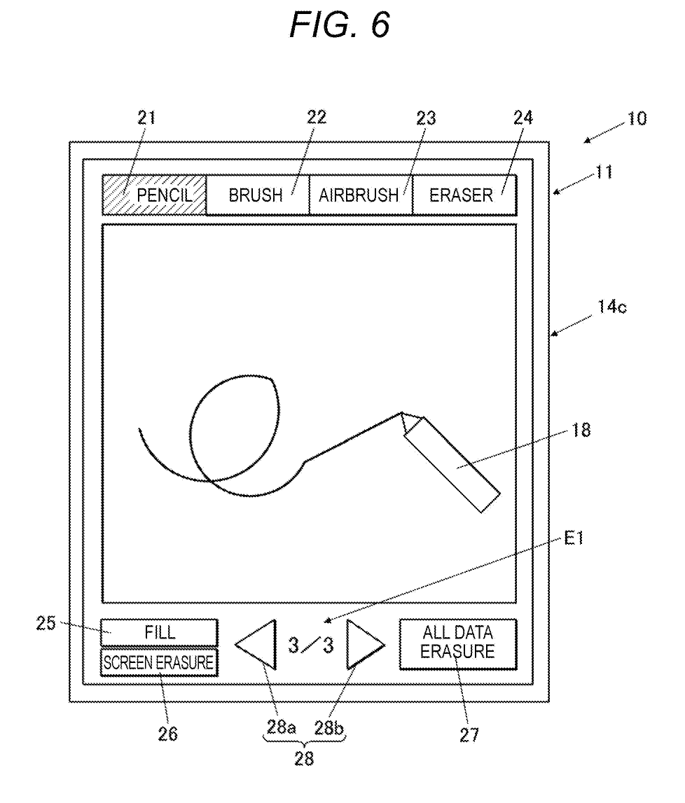

FIG. 6 is a schematic front view of the information processing apparatus 10, the view illustrating the display 14c in a state in which a handwriting input is performed in an input page in the handwriting input mode.

First, information displayed on the display 14c in the handwriting input mode will be described. In the handwriting input mode, as illustrated in FIG. 1 to FIG. 6, various buttons 21 to 28 to execute various operations on an input page are displayed on the display 14c. The buttons 21 to 28 area “pencil” button 21, a “brush” button 22, an “airbrush” button 23, an “eraser” button 24, a “fill” button 25, a “screen erasure” button 26, an “all data erasure” button 27, and a paging button 28. Note that these buttons 21 to 28 are not displayed only in the handwriting input mode but may be displayed constantly. Also, the buttons 21 to 28 are not necessarily displayed on the display 14c to receive an input from a user as long as an input can be received. For example, the buttons 21 to 28 may be configured as hardware buttons in the housing 11 and may receive an input constantly.

The “pencil” button 21, the “brush” button 22, and the “airbrush” button 23 are buttons to draw a character, a figure, or the like on an input page. The “eraser” button 24 is a button to erase a part of the whole of information drawn on an input page. The “fill” button 25 is a button to fill the whole range or a selected range of an input page with a drawing color. Note that a user may previously set whether to fill the whole range or a selected range or a user may perform the setting each time an input to the “fill” button 25 is performed. The “screen erasure” button 26 is a button to erase drawing information drawn on an input page currently displayed on the display 14c at once. The “all data erasure” button 27 is a button to delete a document including an input page currently displayed on the display 14c. Here, a document includes one or more input pages and is stored as one file in the storage apparatus 16.

The paging button 28 is a button which functions as a paging unit to perform paging of an input page in a forward/backward direction. Here, in a case where a currently-displayed input page is a second page, the forward/backward direction is a direction to perform paging to a first page which is a previous or to a third page which is a next page. More specifically, a direction to perform paging to the first page is a forward direction and a direction to perform paging to the third page is a backward direction. The paging button 28 includes a button for paging forward 28a to perform switching of a page in the forward direction and a button for paging backward 28b to perform switching of a page in the backward direction.

Moreover, in the handwriting input mode, the total number of input pages or a page position (number) of a currently-displayed input page relative to the total number of pages of a document including the input page is displayed on the display 14c. Specifically, as illustrated in FIG. 1 and FIG. 6, to a lower part (E1 in drawing) of the display 14c, “a page position (number) of a currently-displayed input page relative to the total number of pages of a document including the input page/the total number of pages” is displayed.

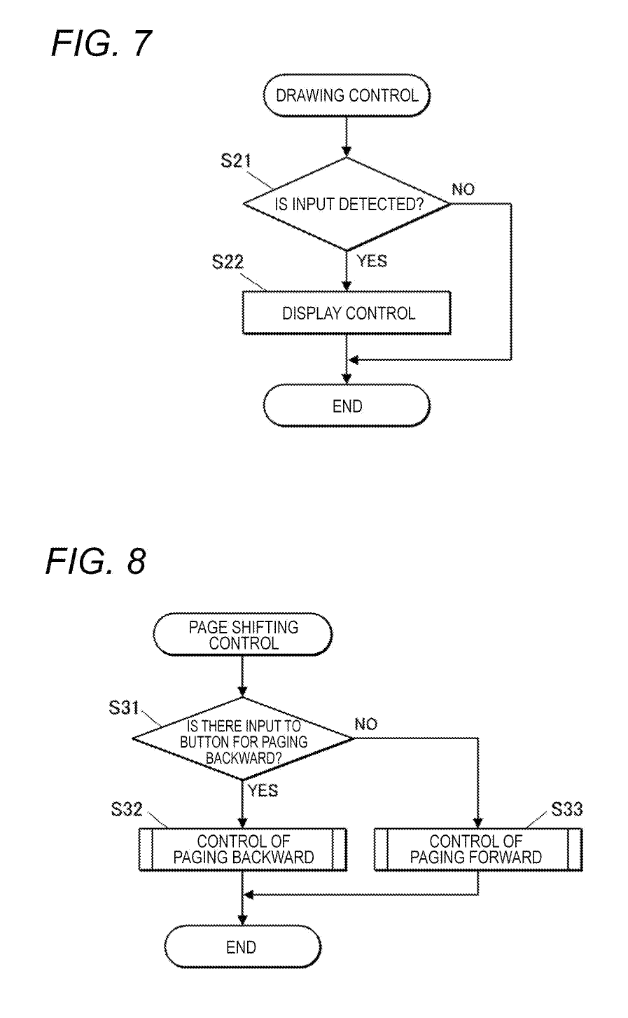

Next, drawing control of the information processing apparatus 10 in a case where a user selects various buttons and performs a handwriting input to the input page while the above-described buttons or the like are displayed on the display 14c will be described with reference to FIG. 7. FIG. 7 is a flowchart illustrating the drawing control on an input page.

First, in step S21, it is determined whether an input into an input page is performed. Here, it is determined whether an input is performed based on determination whether the input information acquiring unit 17b receives, from an input position detecting sensor 19 (see FIG. 4), a notification indicating that an input is detected. The input information acquiring unit 17b receives, from the input position detecting sensor 19, information of an input position along with the notification indicating that an input is detected.

When the system control unit 17a determines that an input into the input page is performed (YES in step S21), display control corresponding to a button arranged at an input position is executed on the display control unit 17e (step S22). Note that the system control unit 17a determines that an input into the input page is performed when receiving, from the input information acquiring unit 17b, a notification indicating that an input is detected and information of an input position.

<Page Shifting Control>

Next, page shifting control of an input page will be described with reference to FIG. 8. FIG. 8 is a flowchart illustrating page shifting control. The page shifting control is control performed in a case where an input to the paging button 28 is performed. Based on an instruction from the system control unit 17a, the display control unit 17e performs the page shifting control.

In step S31, it is determined whether an input to the button for paging backward 28b is performed. When it is determined that an input to the button for paging backward 28b is performed (YES in step S31), control of paging backward is performed (step S32). On the other hand, when it is determined that an input to the button for paging backward 28b is not performed (NO in step S31), it is determined that an input to the button for paging forward 28a is performed and control of paging forward is performed (step S33).

<Control of Paging Backward>

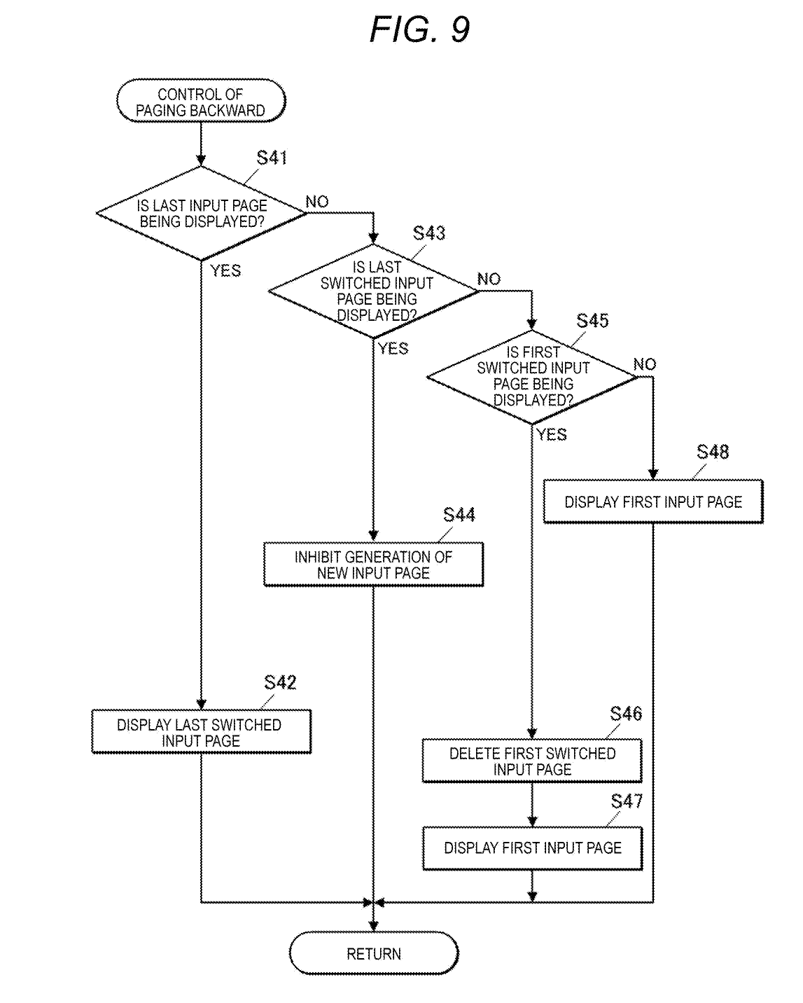

The control of paging backward in step S32 in FIG. 8 will be described with reference to FIG. 9. FIG. 9 is a flowchart illustrating control of paging backward.

In step S41, it is determined whether an input page currently displayed on the display 14c is a last input page. That is, for example, as illustrated in FIG. 1 and FIG. 6, in a case of a document having three pages in total, it is determined whether an input page currently displayed on the display 14c is a third page. Note that in a case where there is only one input page in total, the input page is the first and last input page. When it is determined that the input page is the last input page (YES in step S41), a new blank input page is displayed on the display 14c (step S42). On the other hand, when it is determined that the input page is not the last input page (NO in step S41), processing goes to step S43. In the present embodiment, a blank input page, which is newly displayed on the display 14c when an input to the button for paging backward 28b is performed while the last input page (corresponding to first input page) in a state in which a handwriting input is performed is displayed, is referred to as a last switched input page (corresponding to second input page).

Here, in the related art, a new blank input page generated when an input to the button for paging backward is performed while the last input page is displayed is treated as a last page. Then, in the related art, for example, when an input to the button for paging backward is performed while a third page which is a last input page is displayed, a fourth input page which is the next page is displayed on the display. Moreover, in a case where the number of pages is to be displayed, a page position (number) of the current page relative to the total number of pages is displayed as “4” and the total number of pages is displayed as “4”.

On the other hand, in the present embodiment, the last switched input page is displayed as a new blank input page on the display 14c but is not counted as one page and is not treated as a last page in a document when being blank and until a handwriting input is performed therein. That is, the last switched input page is not treated as one page when being blank. Thus, in the display 14c, the current page position (number) is not displayed and the total number of pages is not changed (increased). That is, in this case, as the total number of pages, the total number of input pages excluding the last switched input page is displayed.

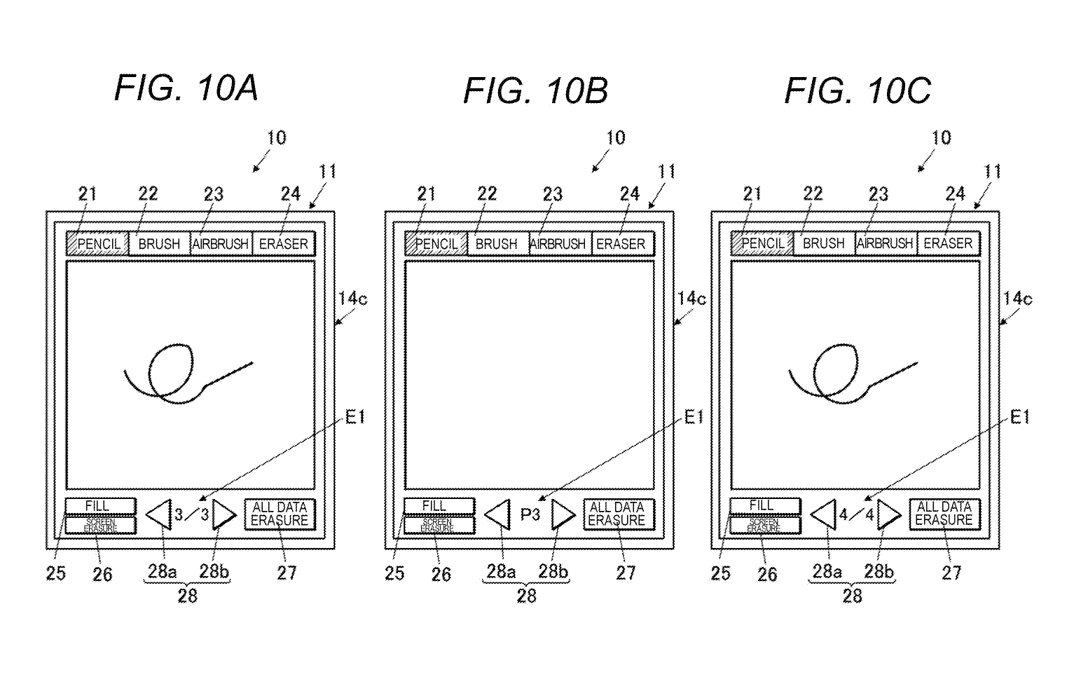

The display control of the number of pages will be described with reference to FIG. 10A to FIG. 10C. In FIG. 10A, an input page which is the last input page (third input page) of a document having three pages in total and which is in a state in which a handwriting input is performed is displayed on the display 14c.

In the state illustrated in FIG. 10A, when an input to the button for paging backward 28b is performed, the last switched input page is displayed on the display 14c as illustrated in FIG. 10B. Here, a handwriting input is not performed and the last switched input page is blank. In the state, since the last switched input page is not counted as one page, a page position (number) relative to the total number of pages is not displayed on the display 14c and only the total number of input pages excluding the last switched input page is displayed on the display 14c. In the present embodiment, when the last switched input page is displayed, combination of a sign “P” indicating that the last switched input page is displayed and “the total number of input pages excluding a last switched input page” is displayed on a lower part (E1 in drawing) of the display 14c. However, the above is not the limitation as long as it can be notified to a user that the last switched input page is displayed and the total number of input pages excluding the last switched input page is notified to the user. Then, when a handwriting input is performed in the last switched input page in the state of FIG. 10B, the last switched input page is counted as one page and becomes a last input page (see FIG. 10C). Here, as illustrated in FIG. 10C, in a lower part (E1 in drawing) of the display 14c, a current page position (number) relative to the total number of pages and the total number of input pages including the fourth input page in which the handwriting input is performed and which becomes the last input page are displayed. Note that whole information input by the handwriting input is deleted after the handwriting input is performed in the last switched input page and the last switched input page becomes the last input page, the input page becomes the last switched input page again.

Referring back to FIG. 9, in step S43, it is determined whether an input page currently displayed on the display 14c is the last switched input page. When it is determined that the input page is the last switched input page (YES in step S43), processing goes to step S44. On the other hand, it is determined that the input page is not the last switched input page (NO in step S43), processing goes to step S45.

In step S44, it is not allowed to display a new input page on the display 14c. Here, in a case where the last switched input page is already displayed on the display 14c, even when an input to the button for paging backward 28b is further performed, a new blank input page is not displayed on the display 14c. Thus, a useless input page can be prevented from being displayed on the display 14c and a plurality of useless input pages is prevented from being generated due to erroneous operation.

In step S45, it is determined whether an input page currently displayed on the display 14c is the first switched input page. When it is determined that the input page is the first switched input page (YES in step S45), processing goes to step S46. On the other hand, when it is determined that the input page is not the first switched input page (NO in step S45), a next input page of the input page currently displayed is displayed on the display 14c (step S48). Here, the first switched input page (corresponding to second input page) is a blank input page newly displayed on the display 14c when an input to the button for paging forward 28a is performed while the first input page (corresponding to first input page) in a state in which a handwriting input is performed is displayed. In the present embodiment, similarly to the last switched input page, the first switched input page is not counted as one page and is not treated as a first page in a document when being blank and until a handwriting input is performed therein. That is, the first switched input page is not treated as one page when being blank. Thus, on the display 14c, the current page position (number) is not displayed and the total number of pages is not changed (increased).

In step S46, the first switched input page is deleted. Then, in step S47, a first input page (next input page of first switched input page) is displayed on the display 14c.

<Control of Paging Forward>

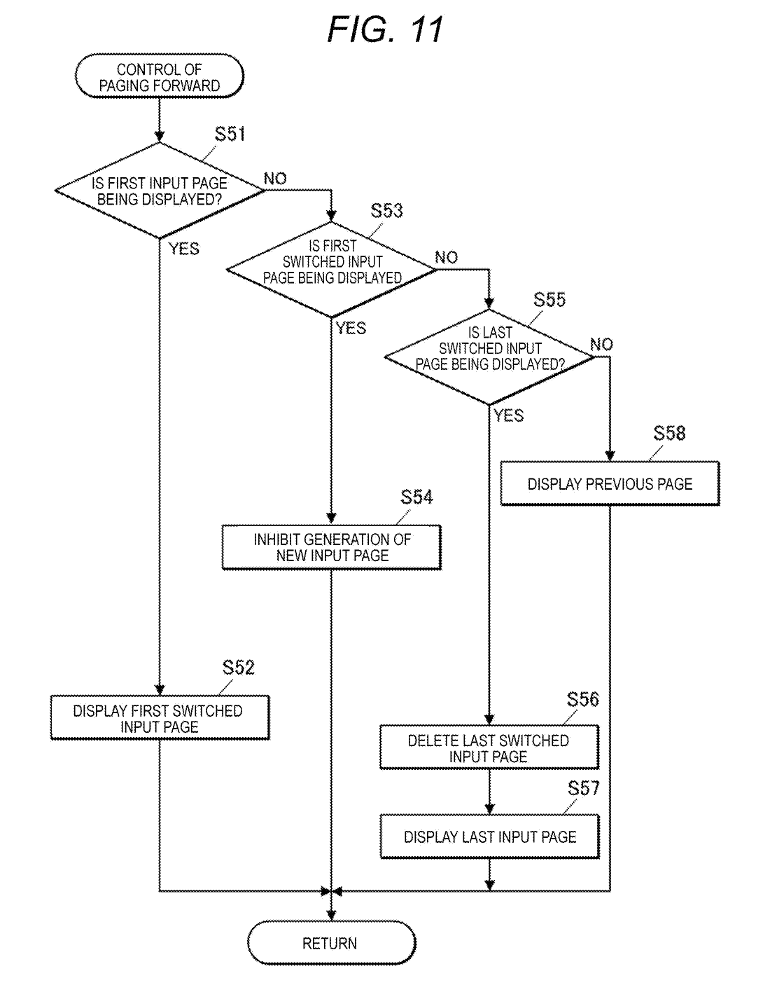

In the following, the control of paging forward in step S33 in FIG. 8 will be described with reference to FIG. 11. FIG. 11 is a flowchart illustrating the control of paging forward.

In step S51, it is determined whether an input page currently displayed on the display 14c is a first input page. That is, for example, in a case of a document having three pages in total, it is determined whether an input page currently displayed on the display 14c is a first page. When it is determined that the input page is the first input page (YES in step S51), processing goes to step S52. On the other hand, it is determined that the input page is not the first input page (NO in step S51), processing goes to step S53.

In step S52, the first switched input page is displayed on the display 14c.

In step S53, it is determined whether an input page currently displayed on the display 14c is the first switched input page. When it is determined that the input page is the first switched input page (YES in step S53), processing goes to step S54. On the other hand, when it is determined that the input page is not the first switched input page (NO in step S53), processing goes to step S55.

In step S54, it is not allowed to display a new input page on the display 14c. Here, in a case where the first switched input page is already displayed on the display 14c, even when an input to the button for paging forward 28a is further performed, a new input page is not displayed on the display 14c. Thus, a useless input page can be prevented from being displayed on the display 14c and a plurality of useless input pages is prevented from being generated due to erroneous operation.

In step S55, it is determined whether an input page currently displayed on the display 14c is the last switched input page. When it is determined that the input page is the last switched input page (YES in step S55), processing goes to step S56. On the other hand, when it is determined that the input page is not the last switched input page (NO in step S55), a previous input page of the currently-displayed input page is displayed on the display 14c (step S58).

In step S56, the last switched input page is deleted. Then, in step S57, a last input page (previous input page of last switched input page) is displayed on the display 14c.

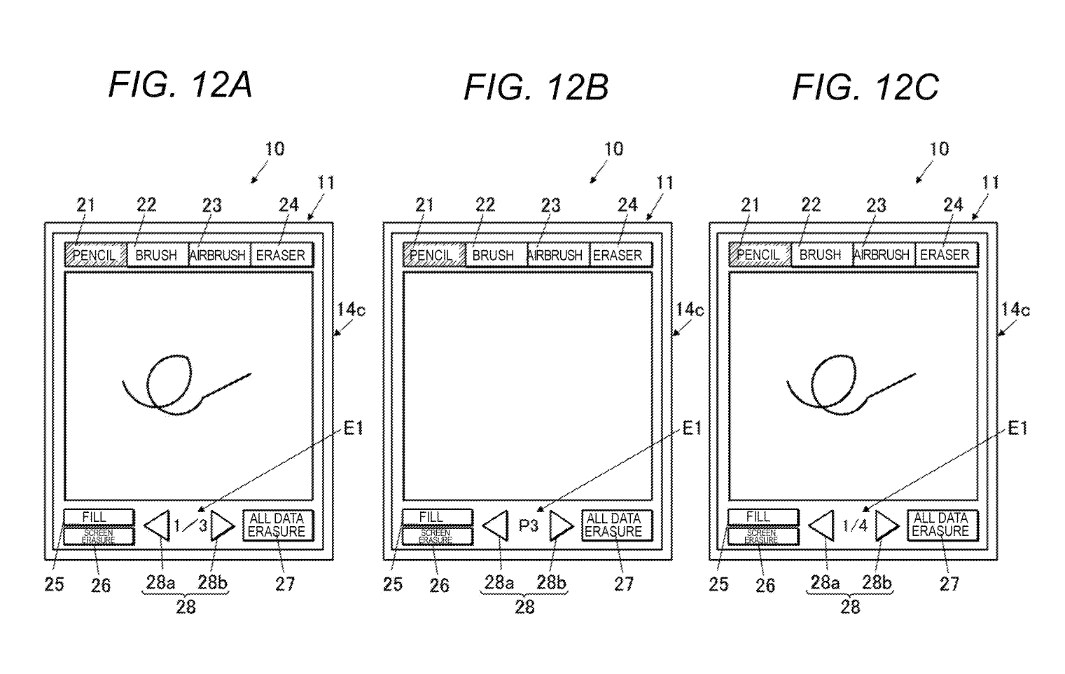

Next, display control of the number of pages in the control of paging forward will be described with reference to FIG. 12A to FIG. 12C. In FIG. 12A, an input page which is a first input page of a document having three pages in total and which is in a state in which a handwriting input is performed is displayed on the display 14c. In the state illustrated in FIG. 12A, when an input to the button for paging forward 28a is performed, a first switched input page is displayed on the display 14c as illustrated in FIG. 12B. Here, a handwriting input is not performed and the first switched input page is blank. In the state, since the first switched input page is not counted as one page, a page position (number) relative to the total number of pages is not displayed on the display 14c and only the total number of input pages excluding the first switched input page is displayed on the display 14c. In the present embodiment, when a first switched input page is displayed, a combination of a sign “P” indicating that a first switched input page is displayed and “the total number of input pages excluding the first switched input page” is displayed on a lower part (E1 in drawing) of the display 14c. However, the above is not the limitation as long as it can be notified that the first switched input page is displayed and the total number of input pages excluding the first switched input page is notified. Then, when a handwriting input is performed in the first switched input page in the state of FIG. 12B, the first switched input page is counted as one page and becomes a first input page (see FIG. 12C). Here, as illustrated in FIG. 12C, in a lower part (E1 in drawing) of the display 14c, a current page position (number) relative to the total number of pages and the total number of input pages including the first input page in which the handwriting input is performed and which becomes the first input page are displayed. Note that whole information input by the handwriting input is deleted after the handwriting input is performed in the first switched input page and the first switched input page becomes the first input page, the input page becomes the first switched input page again.

<Document Storing Control>

The document storing control is control to store, into the storage apparatus 16, one or more input pages in which a handwriting input is performed. Note that a first switched input page or a last switched input page is not stored. In the present embodiment, when a different document is stored in the storage apparatus 16, as the document storing control, there are control (independent document storing control) to store a document, which includes an input page displayed on the display 14c, independently from the different document and control (control of performing adding to an existing document) to add the document which includes an input page displayed on the display 14c to the different document and to store the document as one document. Note that when a different document is not stored in the storage apparatus 16, the independent document storing control is performed automatically. It is determined whether to perform the independent document storing control or the control of performing adding to an existing document based on determination whether an input to a first storing button (not illustrated) to perform the independent document storing control is performed or an input to a second storing button (not illustrated) to perform the control of performing adding to an existing document is performed. Note that the first storing button and the second storing button may be software buttons displayed on the display 14c or may be hardware buttons such as the key switch 14b.

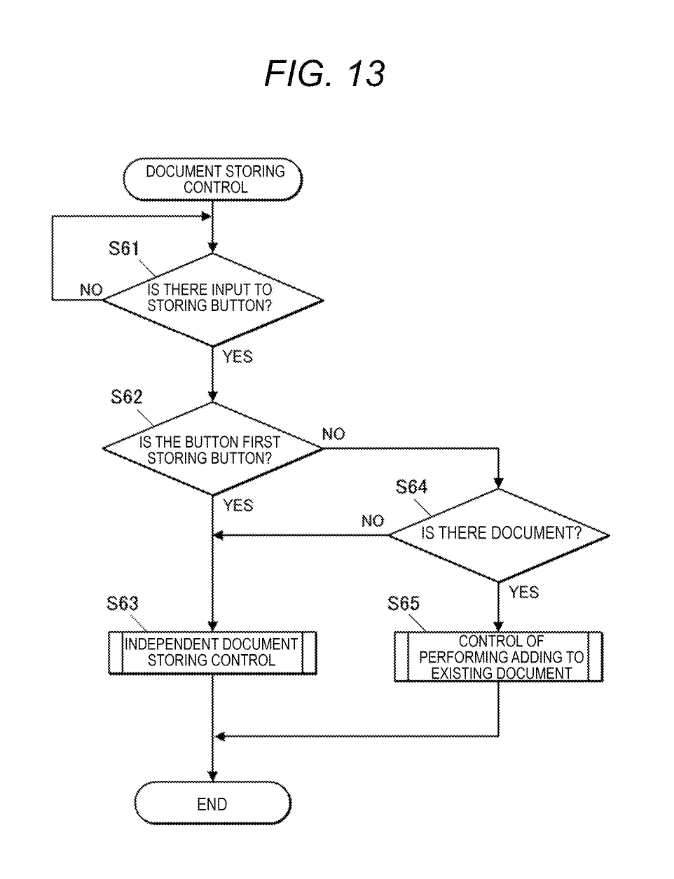

In the following, the document storing control will be described with reference to FIG. 13. FIG. 13 is a flowchart illustrating the document storing control.

In step S61, it is determined whether an input to the storing button is performed. When it is determined that there is an input to the storing button (YES in step S61), it is determined whether the button is the first storing button (step S62). When it is determined that there is no input to the storing button (NO in step S61), waiting is performed until an input to the storing button is performed.

When it is determined in step S62 that the button is the first storing button (YES in step S62), the independent document storing control is performed (step S63). When it is determined that the button is not the first storing button, that is, when it is determined that an input to the second storing button is performed (NO in step S62), it is determined whether a different document is stored in the storage apparatus 16 (step S64).

In step S64, when it is determined that a document is stored in the storage apparatus 16 (YES in step S64), the control of performing adding to an existing document is performed (step S65), when it is determined that no document is stored in the storage apparatus 16 (NO in step S64), the independent document storing control is performed since there is no document to which adding is performed (step S63).

<Independent Document Storing Control>

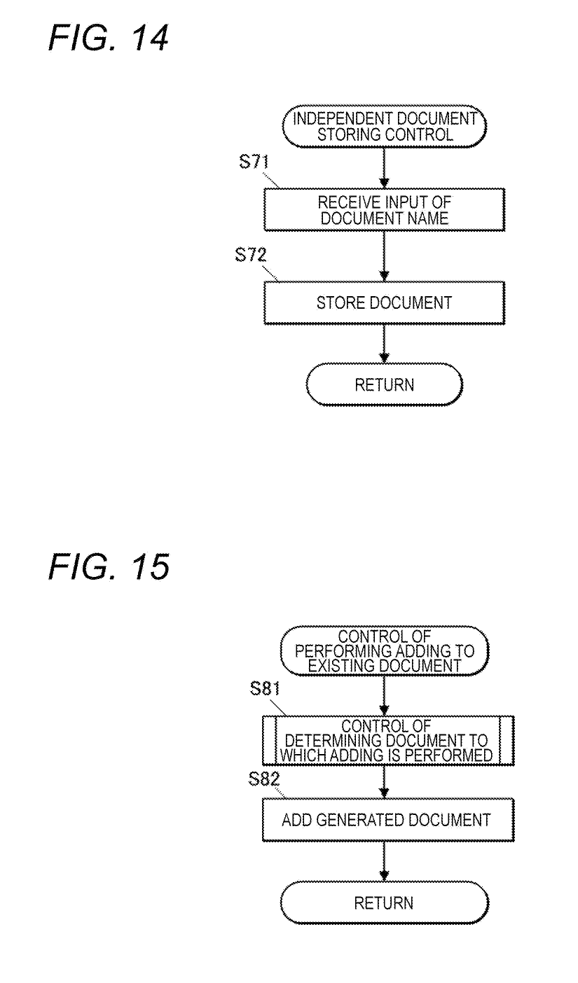

In the following, the independent document storing control will be described with reference to FIG. 14. FIG. 14 is a flowchart illustrating the independent document storing control.

In step S71, an input of a document name is received. More specifically, an input screen to input a document name is displayed on the display 14c and an input from a user is received.

In step S72, a document a name of which is determined is stored into the storage apparatus 16.

<Control of Performing Adding to Existing Document>

In the following, the control of performing adding to an existing document will be described with reference to FIG. 15. FIG. 15 is a flowchart illustrating the control of performing adding to an existing document.

In step S81, control of determining a document to which adding is performed is performed. The control of determining a document to which adding is performed is control to determine to which document stored in the storage apparatus 16 a document including an input page displayed on the display 14c is added.

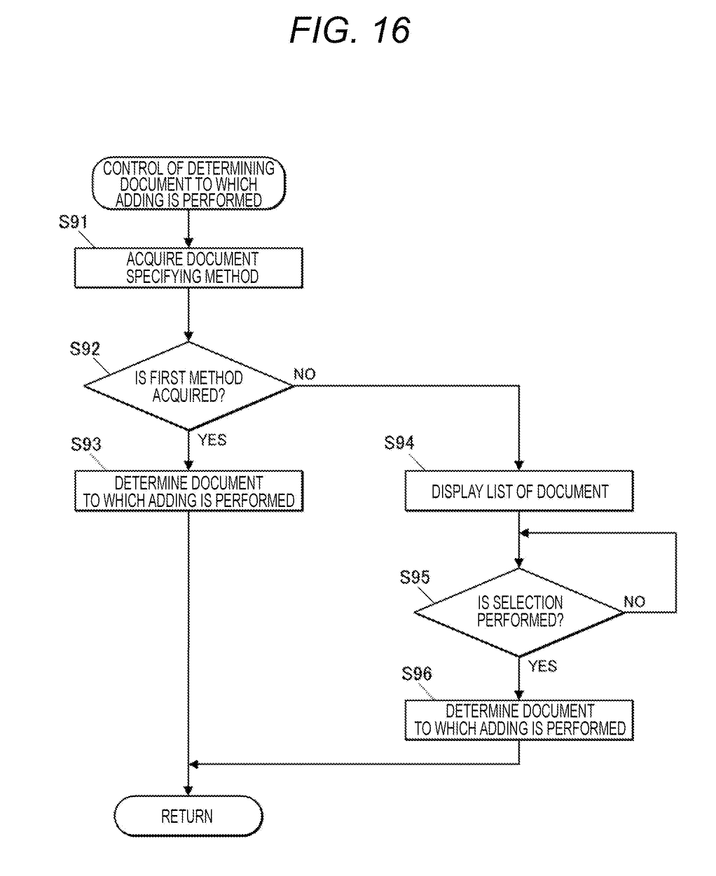

In the following, the control of determining a document to which adding is performed will be described with reference to FIG. 16. FIG. 16 is a flowchart illustrating the control of determining a document to which adding is performed.

In the control of determining a document to which adding is performed, a document specifying method set by a user previously is acquired in step S91. The document specifying method is a method to specify a document to which a document including an input page displayed on the display 14c is added. As the document specifying method, there are a first method to automatically set a predetermined document stored in the storage apparatus 16 and a second method to make a user perform selection by displaying one or more lists of documents stored in the storage apparatus 16 on the display 14c. In the present embodiment, a user previously sets whether to use the first method or the second method as the document specifying method. However, when there is an input to the second storing button, a screen for selection of the first method or the second method may be displayed on the display 14c and a user may be made to select a document specifying method. Also, in the present embodiment, a predetermined document set automatically in the first method is set by a user previously.

In step S92, it is determined whether the document specifying method acquired in step S91 is the first method. When it is determined that the acquired method is the first method (YES in step S91), a predetermined document set by a user previously is determined as the document to which adding is performed (step S93). Then, to the predetermined document, a document including an input page currently displayed on the display 14c is added and the document is stored (step S82 in FIG. 15). That is, a document including an input page displayed on the display 14c and a document to which the document is added are stored as one document into the storage apparatus 16. On the other hand, when it is determined that the acquired method is not the first method (NO in step S91), one or more lists of documents stored in the storage apparatus 16 are displayed on the display 14c in a selectable manner (step S94). Then, it is determined whether one document is selected from the one or more lists of documents displayed on the display 14c (step S95). When it is determined that one document is selected (YES in step S95), the selected document is determined as a document to which adding is performed (step S96) and a document including an input page currently displayed on the display 14c is added to the selected document (step S82 in FIG. 15). When it is determined that one document is not selected from the one or more lists of documents (NO in step S95), waiting is performed until one document is selected from the one or more lists of documents.

Then, when an end button (not illustrated) to end the handwriting input mode is pressed, the handwriting input mode is ended. The end button may be a software button displayed on the display 14c or may be a hardware button.

(3) Characteristic (3-1)

In the present embodiment, when an input for paging in a first direction is performed by a user through the paging buttons 28a and 28b while the display control unit 17e of the control apparatus 17 displays, on the display 14c as a display unit, a first or last input page (corresponding to first input page) in a state in which a handwriting input is performed, a new input page (first switched input page or last switched input page (corresponding to second input page)) is displayed on the display 14c. Here, when the first input page is displayed, the input for paging in the first direction means an input for paging forward performed through the button for paging forward 28a. When the last input page is displayed, the input for paging in the first direction means an input for paging backward performed through the button for paging backward 28b. Note that input information input by a user through the input/output apparatus 14 is acquired by the input information acquiring unit 17b.

Here, conventionally, in a word processor application, a drawing application, or the like, there is a case where a blank part to input a character or an image becomes insufficient in a page currently displayed or a case where a user desires to input a character or an image in a new page. Thus, for example, an apparatus in which a new blank page is added automatically when operation of paging backward is performed, such as the information processing apparatus disclosed in JP 6-113060 A has been proposed.

However, in the information processing apparatus disclosed in JP 6-113060 A, a new blank page is added each time an input for paging backward is performed. Thus, in a case where an unnecessary blank page is generated due to an operational mistake or in a case where an intentionally-added blank page becomes unnecessary, a useless blank page remains when the blank page is left as it is.

Thus, in the present embodiment, when an input for paging is performed by a user in a second direction which is the opposite direction of the first direction through the paging buttons 28a and 28b while a handwriting input is not performed in the a first switched input page or a last switched input page displayed on the display 14c, the first switched input page or the last switched input page as a second input page is deleted automatically and is not left.

Then, by the paging in the second direction, a first input page (that is, next input page of first switched input page or previous input page of last switched input page) displayed on the display 14c is set as a first or last input page.

On the other hand, when a handwriting input is performed in a first switched input page or a last switched input page, the first switched input page or the last switched input page in which the handwriting input is performed remains even when the input for paging in the second direction is performed. That is, the first switched input page and the last switched input page in which a handwriting input is performed are treated respectively as the first and the last input page.

As described above, in the present embodiment, by simple operation to perform an input to the paging buttons 28a and 28b, a new blank input page (first switched input page or last switched input page) is generated. Then, although being displayed on the display 14c, the first switched input page or the last switched input page is automatically deleted when an input in the second direction is performed while the page is blank. Thus, even when the first switched input page or the last switched input page becomes unnecessary or even when the first switched input page or the last switched input page is generated by erroneous operation of a user, the first switched input page or the last switched input page is deleted easily when the user performs an input to the paging button 28a or 28b. Thus, remaining of a useless blank input page can be controlled.

(3-2)

In the present embodiment, when a handwriting input is performed in the first switched input page or the last switched input page, the control apparatus 17 counts the page as one page. In such a manner, in the present embodiment, when the first switched input page or the last switched input page is counted as one page, it is necessary that a handwriting input is performed by a user. When a handwriting input is not performed by a user, the page is not counted as one page. Since each of the first switched input page and the last switched input page has such an attribution, the first switched input page and the last switched input page can be easily deleted only by the paging when the first switched input page and the last switched input page are not necessary for the user. Thus, convenience for a user can be improved.

(3-3)

In the present embodiment, the control apparatus 17 displays, on the display 14c, the total number of pages of one document including an input page displayed on the display 14c. Then, when a handwriting input is performed in the first switched input page or the last switched input page and the page is counted as one page, the control apparatus 17 increases the total number of pages displays on the display 14c.

In such a manner, when the first switched input page or the last switched input page is counted as one page, the total number of input pages is increased. Thus, the total number of input pages can be recognized by a user at a glance.

(3-4)

In the information processing apparatus 10 in which a new input page is easily generated by an input to the paging button 28a or 28b, such as what is described in the present embodiment, it is considered that a plurality of input pages may be generated by erroneous operation.

Thus, in the present embodiment, even when an input for paging in a first direction is performed through the paging button 28a or 28b while a first switched input page or a last switched input page is displayed, in which no handwriting input is performed, on the display 14c, the control apparatus 17 does not display a new input page on the display 14c. That is, it is not allowed to display a new input page on the display 14c.

Thus, generation of a plurality of useless input pages due to erroneous operation can be prevented from being generated. Also, in the related art, when a plurality of useless input pages is generated, it is necessary to delete the unnecessary input pages one by one. However, in the present embodiment, a plurality of useless input pages is prevented from being generated previously, and thus, such processing is not necessary.

(4) Modification

In the above, the first embodiment of the present invention has been described with reference to the drawings. However, a detail configuration is not limited to the above-described first embodiment and modification can be made within the spirit and the scope of the invention. In the following, a different embodiment of the present invention will be described.

(4-1) Modification 1A

In the information processing apparatus 10 according to the first embodiment, in both of a case where a first input page is displayed on the display 14c and a case where a last input page is displayed thereon, when an input for paging in a first direction is performed, a first switched input page or a last switched input page which is a new input page is displayed on the display 14c. However, the above is not the limitation. For example, instead of the information processing apparatus 10 of the first embodiment, an information processing apparatus 200 may be used.

In the information processing apparatus 200, instead of the control setting in the information processing apparatus 10, control setting to display a first switched input page or a last switched input page on a display 14c when an input for paging in a first direction is performed only in either of a case where a first input page is displayed on the display 14c and a case where a last input page is displayed thereon can be performed.

In the following, a storage apparatus 216 which is a difference between the information processing apparatus 200 and the information processing apparatus 10 will be described. Note that to a configuration similar to that of the information processing apparatus 10 according to the first embodiment, the same number is assigned and description thereof is omitted.

<Configuration>

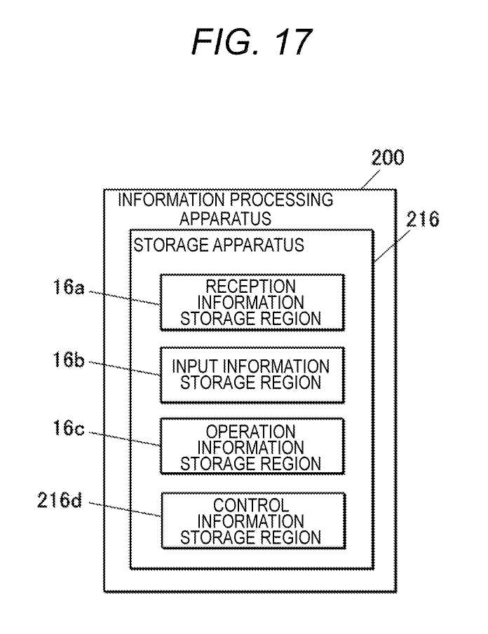

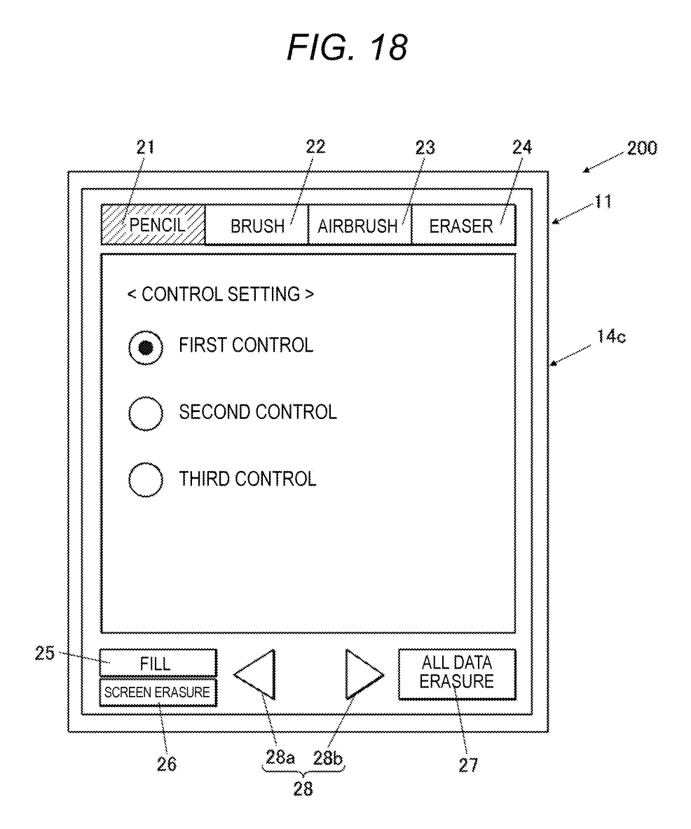

FIG. 17 is a functional configuration diagram of the storage apparatus 216 of the information processing apparatus 200 according to the modification 1A. FIG. 18 is a schematic front view of the information processing apparatus 200 according to the modification 1A.

The storage apparatus 216 is housed inside a housing 11.

As illustrated in FIG. 17, the storage apparatus 216 includes a control information storage region 216d other than a reception information storage region 16a, an input information storage region 16b, and an operation information storage region 16c.

The control information storage region 216d is a region to store a plurality of pieces of control information. As the plurality of pieces of control information, there are pieces of information related to first control, second control, and third control.

The first control is control to display a first switched input page on the display 14c when an input for paging in a first direction is performed only in a case where a first input page is displayed on the display 14c. That is, in the first control, even when an input for paging in a first direction is performed while a last input page is displayed on the display 14c, a last switched input page is not displayed on the display 14c. The second control is control to display a last switched input page on the display 14c when an input for paging in a first direction is performed only in a case where a last input page is displayed on the display 14c. That is, in the second control, even when an input for paging in a first direction is performed while a first input page is displayed on the display 14c, a first switched input page is not displayed on the display 14c. The third control is control to display a first switched input page or a last switched input page on the display 14c when an input for paging in a first direction is performed in both of a case where a first input page is displayed on the display 14c and a case where a last input page is displayed thereon, similarly to that in the information processing apparatus 10 of the first embodiment.

<Control>

In the information processing apparatus 200, when a user performs an input to a button (not illustrated) to determine the first to third controls, based on an instruction from a system control unit 17a to which a notification indicating that an input is performed by a user on the button is provided from an input information acquiring unit 17b, a display control unit 17e displays, on the display 14c, a selection screen for selection of one kind of control among three kinds of control (see FIG. 18). Accordingly, a user can select intended control from a plurality of kinds of control.

Then, when one kind of control is selected by a user, first, the input information acquiring unit 17b acquires information of the control selected by the user and notifies the control selected by the user to the system control unit 17a. When receiving the notification from the input information acquiring unit 17b, the system control unit 17a gives an instruction to the display control unit 17e to execute display control in the control.

In such a manner, in the information processing apparatus 200, it is possible to perform display switching into a new input page according to an intention or utilization condition of a user. Thus, convenience for a user is improved.

Moreover, the control information storage region 216d may include information of switching inhibition control other than the above three kinds of control information. The switching inhibition control is control not to display a first switched input page or a last switched input page on the display 14c even when an input for paging in a first direction is performed in both of a case where a first input page is displayed on the display 14c and a case where a last input page is displayed thereon. In this case, control corresponding to an intention or utilization condition of a user can be performed.

(4-2) Modification 1B

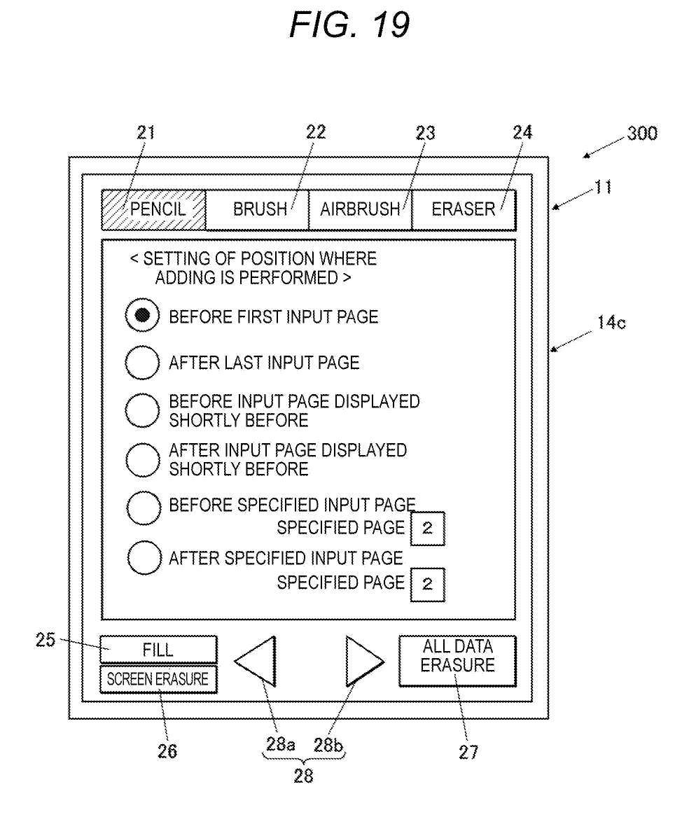

FIG. 19 is a schematic front view of an information processing apparatus 300 according to the present modification 1B.

In the first embodiment, the control of determining a document to which adding is performed has been described. However, a user may previously set a position where a document including an input page displayed on the display 14c is added in a document to which adding is performed.

In this case, an input to a button (not illustrated) to determine a position where adding is performed in the document to which adding is performed is performed by a user. Thus, as illustrated in FIG. 19, a selection screen for selection of a position where adding is performed in the document to which adding is performed is displayed on the display 14c. Then, the user selects, on the selection screen displayed on the display 14c, a predetermined position where adding is performed in the document to which adding is performed. Thus, the predetermined position where adding is performed in the document to which adding is performed is determined. As the position where adding is performed in the document to which adding is performed, there are a position before a first input page, a position after a last input page, a position before an input page displayed shortly before, a position after an input page displayed shortly before, a position before an input page specified by a user, and a position after an input page specified by a user. When a user specifies an input page, the user can input a page position (number) in a box to input a specified input page.

In the present modification, since a user can determine a position where adding is performed in the document to which adding is performed, processing corresponding to an intention or utilization condition of a user becomes possible and convenience for the user can be improved.

Note that the position where adding is performed in the document to which adding is performed may not be determined by a user. After the control of determining a document to which adding is performed (step S81 in FIG. 15) of the first embodiment is performed, the selection screen illustrated in FIG. 19 may be displayed on the display 14c and selection may be performed by a user.

Also, when a user specifies an input page and in a case where the input page specified by the user does not exist, a position (such as position before first input page or position after last input page) where adding is performed may be set previously or at each time.

(4-3) Modification 1C

In the first embodiment, it has been described that a first switched input page or a last switched input page is deleted when an input for paging in a second direction is performed through the paging button 28a or 28b while the first switched input page or the last switched input page is displayed in a blank state on the display 14c. However, in such a case, a user may be able to set previously whether to delete the first switched input page and the last switched input page.

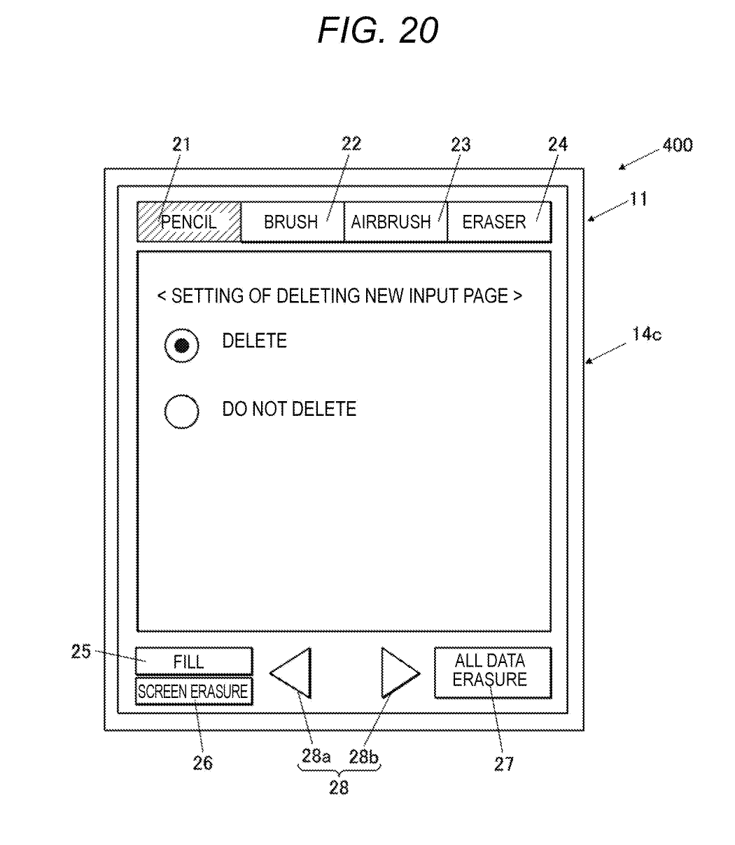

In this case, when an input to a setting button (not illustrated) for determining whether to delete the first switched input page and the last switched input page is performed by a user, a selection screen to make a user select whether to delete the first switched input page and the last switched input page is displayed on the display 14c (see FIG. 20). Here, FIG. 20 is a schematic front view of an information processing apparatus 400 in a state in which a selection screen for determination whether to delete a first switched input page and a last switched input page is displayed on a display 14c.

In the present modification, since a user can determine whether to delete a first switched input page and a last switched input page, processing corresponding to an intension or utilization condition of the user becomes possible and convenience for the user can be improved.

(4-4) Modification 1D

On a display 14c, time and date may be displayed other than the items described in the first embodiment. The time and date information is managed by a timer unit (not illustrated) of a control apparatus 17 and is periodically notified to a system control unit 17a. Also, when an information processing apparatus 10 performs wireless communication with an external apparatus, radio wave intensity may be displayed on the display 14c. The information of the radio wave intensity is managed by a radio wave intensity managing unit (not illustrated) and is periodically notified to the system control unit 17a. Thus, more information can be provided to a user.

(4-5) Modification 1E

In the first embodiment, it has been described that a first switched input page or a last switched input page is counted as one page when a handwriting input is performed in the first switched input page or the last switched input page. However, for example, the first switched input page or the last switched input page may be treated as one page when an input to a handwriting input confirmation button (not illustrated) is performed by a user after a handwriting input is performed by the user in the first switched input page or the last switched input page.

Also, each time a handwriting input is performed in one first switched input page or last switched input page, or each time an input to the handwriting input confirmation button is performed, a user may select whether to perform independent document storing control to store the input page independently into a storage apparatus 16 or control of performing adding to an existing document to add the input page to an existing document. In this case, each time a handwriting input into a new blank input page is performed, it is possible to determine whether to store the input page as an independent document or to add the input page to an existing document. Thus, convenience for a user can be improved.

Note that similarly to the Modification 1B, in the present modification, when the control of performing adding to an existing document is performed, a position where adding is performed in an existing document to which adding is performed may be determined by a user previously or at each time.

(4-6) Modification 1F

Other than the first embodiment, a user may be able to determine a position, where a newly generated input page is inserted and displayed, in a whole document previously or at each time.

### Second Embodiment

In the following, a second embodiment of the present embodiment will be described. Note that to a configuration similar to that of the information processing apparatus 10 according to the first embodiment, the same number is assigned and description thereof is omitted. In an information processing apparatus 500 according to the second embodiment, display order of a document stored in a storage apparatus 16 onto a display 14c is determined. When paging is performed through paging buttons 28a and 28b, a plurality of documents is serially displayed on the display 14c in this display order.

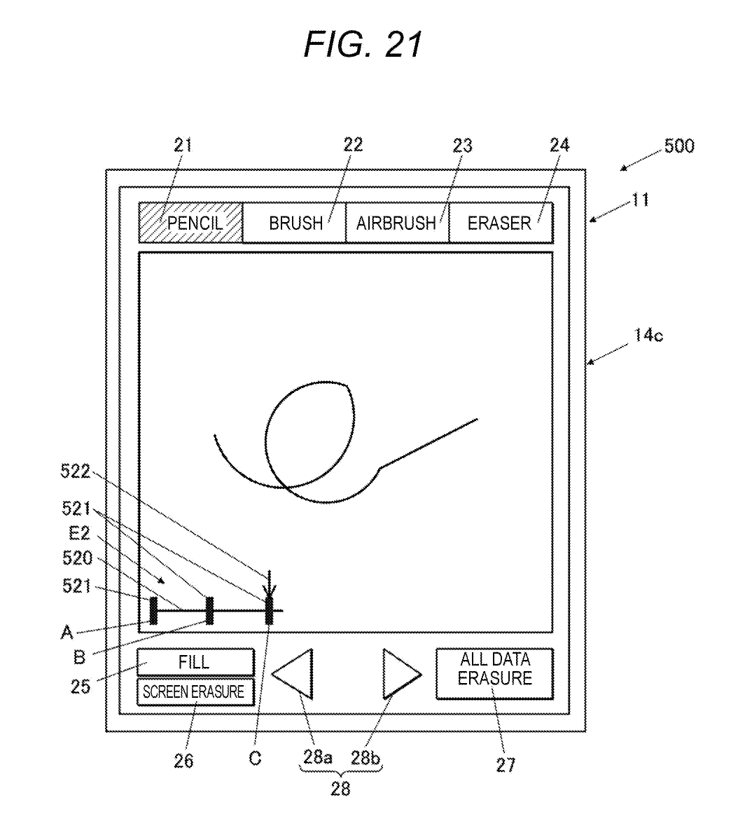

In the following, the information processing apparatus 500 will be described with reference to FIG. 21 to FIG. 23.

(1) Configuration

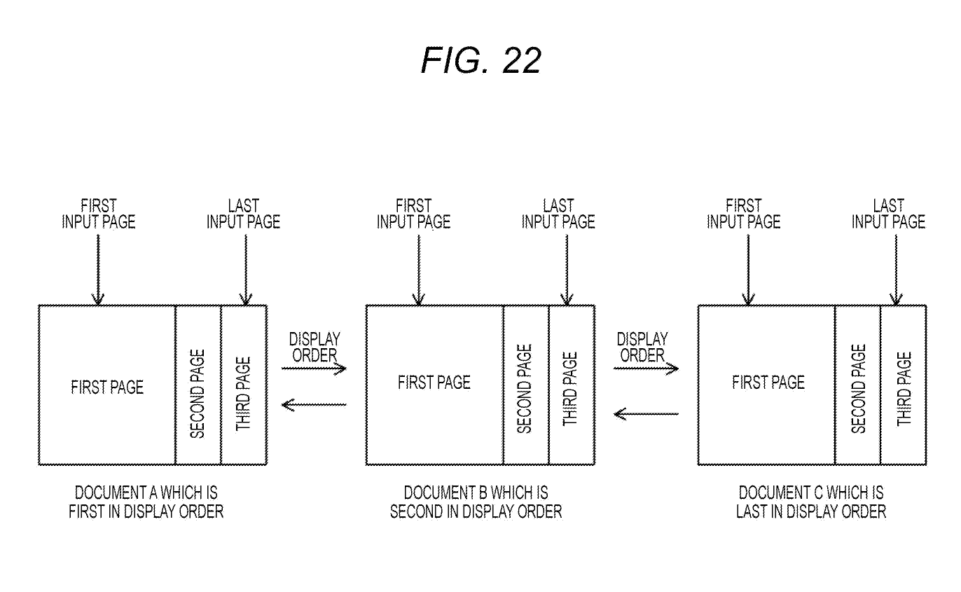

FIG. 21 is a schematic front view of the information processing apparatus 500. FIG. 22 is a schematic view of an input page which view is for describing display order on the display 14c.

Similarly to the information processing apparatus 10, the information processing apparatus 500 includes a handwriting input mode. As illustrated in FIG. 21, in a handwriting input mode of the information processing apparatus 500, a one-dimensional bar 520 is displayed at a predetermined position (lower left part E2 of display 14c in present embodiment) on the display 14c. Then, on the bar 520, a mark 521 corresponding to a document stored in the storage apparatus 16 is displayed. One mark 521 is displayed for one document. Here, in FIG. 21, three documents A to C (see FIG. 22) are stored in the storage apparatus 16 and a predetermined input page in the document C is displayed on the display 14c. In the display 14c, the left mark 521 is a mark corresponding to the document A which is the first in display order. The center mark 521 is a mark corresponding to the document B which is the second in the display order. The right mark 521 is a mark corresponding to the document C which is the last in the display order. In the present embodiment, for example, when an input to a button for paging backward 28b is performed while a last input page of the document A is displayed on the display 14c, a first input page of the document B is displayed on the display 14c (see FIG. 22). Also, when an input to a button for paging forward 28a is performed while the first input page of the document B is displayed on the display 14c, the last input page of the document A is displayed on the display 14c (see FIG. 22).

Also, in the present embodiment, for example, an input to the button for paging backward 28b is performed while a last input page of the document B is displayed on the display 14c, a first input page of the document C is displayed on the display 14c as illustrated in FIG. 22. Also, when an input to the button for paging forward 28a is performed while the first input page of the document C is displayed on the display 14c, the last input page of the document B is displayed on the display 14c as illustrated in FIG. 22.

Note that as a displayed object corresponding to a document displayed on the display 14c, a character (such as alphanumeric character or Chinese character) may be displayed instead of the mark 521. For example, an initial letter of a saved file name of a document or a number indicating display order (1, 2, . . . N) maybe displayed. Note that the displayed object may be displayed on an upper side or a lower side of the bar 520.

Also, in the present embodiment, a document including an input page currently displayed on the display 14c is indicated by an arrow mark 522 (see FIG. 21). Thus, a position of the document including the input page currently displayed on the display 14c can be recognized by a user at a glance. Note that a mark, a character, or the like other than the arrow mark 522 maybe used as long as the document including the input page currently displayed on the display 14c can be indicated to a user.

Moreover, in the present embodiment, when a user touches the mark 521, a first input page included in a document corresponding to the touched mark 521 is displayed on the display 14c. Note that here, the first input page is displayed on the display 14c. However, a displayed input page may be set by a user previously or may be set by a user on a setting screen displayed at this stage.

(2) Control

In respect to control in the present embodiment, only a point different from the control in the first embodiment will be described.

<Input Page Display Control>

In the present embodiment, when a setting instruction for a handwriting input mode is provided (step S1 in FIG. 5), processing goes to step S4 and a list of files stored in the storage apparatus 16 is displayed on the display 14c. Then, step S5 and step S6 are executed.

<Drawing Control on Input Page>

As described above, in the present embodiment, when an input to the paging button 28a or 28b is performed, a first input page of a document in next display order or a last input page of a document in previous display order may be displayed on the display 14c.

Note that other than the total number of pages of a document including an input page displayed on the display 14c and a page position (number) of the input page displayed on the display 14c relative to the total number of pages, the total number of pages of all documents stored in the storage apparatus 16 may be further displayed.

<Page Shifting Control>

A first input page in the first embodiment is a first input page of a document which is the first in display order in the second embodiment. A last input page in the first embodiment is a last input page of a document which is the last in the display order in the second embodiment. That is, in the present embodiment, when an input for paging in a first direction is performed through the paging button 28a or 28b while the first input page of the document which is the first in the display order or the last input page of the document which is the last in the display order is displayed, on the display 14c, in a state in which a handwriting input is performed, a first switched input page or a last switched input page is displayed on the display 14c.

Also, when a last input page of a document which is the Nth in the display order is displayed, there is a case where a “next page” in step S48 (FIG. 9) in the first embodiment is a first input page of a document which is the N+1th in the display order. When a first input page of a document which is the Nth in the display order is displayed, there is a case where a “previous page” in step S58 (FIG. 11) in the first embodiment is a last input page of a document which is the N−1th in the display order.

Note that a method of displaying the first switched input page and the last switched input page is not limited to the above-described method. For example, when an input to the button for paging backward 28b is performed while a last input page of the document which is the Nth in the display order is displayed, a last switched input page may be displayed. Here, when an input to the button for paging backward 28b is further performed, the last switched input page is deleted and a first input page of the document which is the N+1th in the display order is displayed. Also, when an input to the button for paging forward 28a is performed while a first input page of the document which is the Nth in the display order is displayed, a first switched input page may be displayed. Here, when an input to the button for paging forward 28a is further performed, the first switched input page is deleted and a last input page of the document which is the N−1th in the display order is displayed.

<Control of Document to which Adding is Performed in Control of Performing Adding to Existing Document>

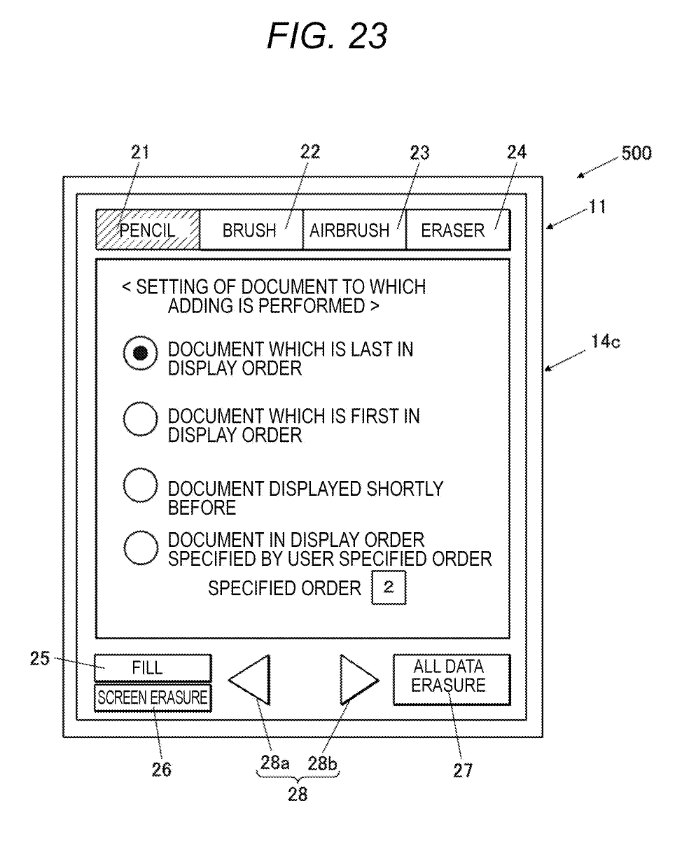

As illustrated in FIG. 23, a user may previously select whether to set, as a document to which adding is performed, a “document which is the last in display order”, a “document which is the first in display order”, a “document displayed shortly before”, or a “document in display order specified by a user”. When the “document in display order specified by a user” is selected, an input box for an input of the specified display order is displayed in such a manner that the display order can be input. Here, FIG. 23 is a schematic front view of the information processing apparatus 500 in a state in which a setting screen for determination of a document to which adding is performed is displayed on the display 14c.

(3) Characteristic

In the present embodiment, by an input to the paging button 28, documents stored in the storage apparatus 16 can be displayed serially on the display 14c. In the present embodiment, by simple operation of performing an input to the paging button 28, all documents stored in the storage apparatus 16 can be displayed on the display 14c. Also, only by a touch on the mark 521, an input page included in a document corresponding to the mark 521 can be easily displayed on the display 14c. Thus, convenience for a user is improved.

Also, by the mark 521 or the arrow mark 522, the number of documents stored in the storage apparatus 16 or a position of a document including an input page currently displayed on the display 14c can be recognized at a glance.

(4) Modification

In the independent document storing control, a setting screen to make a user set display order of a document may be displayed on the display 14c after a document name is determined in step S71 (FIG. 14). For example, on the setting screen, a user selects whether to set a document, the name of which is determined, as a “document which is the last in display order”, a “document which is the first in display order”, a “document before/after a document displayed shortly before”, or a “document in display order specified by a user”. When the “document in display order specified by a user” is selected, an input box to specify the display order is displayed in such a manner that the display order can be input. Note that the above setting may not be performed after step S71 and may be set by a user previously.

Thus, convenience for a user is improved.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An information processing apparatus in which a handwriting input can be performed, comprising:
a display unit configured to display an input page in which a handwriting input can be performed;
an input unit which includes a paging unit configured to perform paging of the input page in forward and backward directions and which is configured to receive an input from a user, the input including the handwriting input into the input page; and
a control unit configured to perform control of displaying in the display unit based on the input from the user which input is received through the input unit, wherein
the control unit displays a new second input page on the display unit when an input for paging in a first direction, which is one of the forward and backward directions and in which no input page exists, is performed through the paging unit while a first or last page of a first input page in which a handwriting input is performed is displayed on the display unit,
the second input page is not left and the first input page is set as a first or last input page when an input for paging in a second direction which is an opposite direction of the first direction is performed through the paging unit while no handwriting input is performed in the second input page displayed on the display unit, and
the second input page in which a handwriting input is performed is left when the input for paging in the second direction is performed while the handwriting input is performed in the second input page displayed on the display unit.

2. The information processing apparatus according to claim 1, wherein the control unit counts the second input page, in which the handwriting input is performed, as one page.

3. The information processing apparatus according to claim 2, wherein the display unit further displays a total number of input pages, and
the control unit increases the total number of input pages displayed on the display unit when the second input page in which the handwriting input is performed is counted as one page.

4. The information processing apparatus according to claim 1, wherein the control unit does not display a new input page on the display unit even when the input for paging in the first direction is performed through the paging unit while the second input page in which no handwriting input is performed is displayed on the display unit.

5. The information processing apparatus according to claim 1, wherein the control unit performs, as control to display the second input page on the display unit, one of the following kinds of control:
first control to display the second input page on the display unit when the input for paging in the first direction is performed only in a case where the first page of the first input page is displayed on the display unit;
second control to display the second input page on the display unit when the input for paging in the first direction is performed only in a case where the last page of the first input page is displayed on the display unit; and
third control to display the second input page on the display unit when the input for paging in the first direction is performed in both of the case where the first page of the first input page is displayed on the display unit and the case where the last page of the first page is displayed thereon.

6. The information processing apparatus according to claim 1, wherein in a case where there is a plurality of documents including the input page, the control unit displays the second input page on the display unit when the input for paging in the first direction is performed through the paging unit while a first input page in a document which is first in display order among the plurality of documents or a last input page in a document which is last in display order among the plurality of documents is displayed.

7. A non-transitory recording medium storing a computer readable program which processes information for causing an information processing apparatus, in which a handwriting input can be performed and which includes a display unit configured to display an input page on which a handwriting input can be performed and an input unit which includes a paging unit configured to perform paging of the input page in forward and backward directions and which is configured to receive an input from a user which input includes a handwriting input into the input page, to make the display unit display a new second input page on the display unit when an input for paging in a first direction, which is one of the forward and backward directions and in which no input page exists, is performed through the paging unit while a first page or last page of a first input page in which a handwriting input is performed is displayed on the display unit,
not to leave the second input page and to set the first input page as a first or last input page when an input for paging in a second direction which is an opposite direction of the first direction is performed through the paging unit while no handwriting input is performed in the second input page displayed on the display unit, and
to leave the second input page in which a handwriting input is performed when the input for paging in the second direction is performed while the handwriting input is performed in the second input page displayed on the display unit.

8. The non-transitory recording medium storing a computer readable program which processes information according to claim 7, wherein the second input page in which the handwriting input is performed is counted as one page.

9. The non-transitory recording medium storing a computer readable program which processes information according to claim 8, wherein a total number of input pages is further displayed on the display unit, and
the total number of the input pages displayed on the display unit is increased when the second input page in which the handwriting input is performed is counted as one page.

10. The non-transitory recording medium storing a computer readable program which processes information according to claim 7, wherein a new input page is not displayed on the display unit even when the input for paging in the first direction is performed through the paging unit while the second input page in which no handwriting input is performed is displayed on the display unit.

11. The non-transitory recording medium storing a computer readable program which processes information according to claim 7, wherein as control to display the second input page on the display unit, one of the following kinds of control is performed:
first control to display the second input page on the display unit when the input for paging in the first direction is performed only in a case where the first page of the first input page is displayed on the display unit;
second control to display the second input page on the display unit when the input for paging in the first direction is performed only in a case where the last page of the first input page is displayed on the display unit; and
third control to display the second input page on the display unit when the input for paging in the first direction is performed in both of the case where the first page of the first input page is displayed on the display unit and the case where the last page of the first input page is displayed thereon.

12. The non-transitory recording medium storing a computer readable program which processes information according to claim 7, wherein in a case where there is a plurality of documents including the input page, the second input page is displayed on the display unit when the input for paging in the first direction is performed through the paging unit while a first input page in a document which is first in display order among the plurality of documents or a last input page in a document which is last in the display order among the plurality of documents is displayed.

13. An information processing method in an information processing apparatus in which a handwriting input can be performed and which includes a display unit configured to display an input page in which a handwriting input can be performed, and an input unit which includes a paging unit configured to perform paging of the input page in forward and backward directions and which is configured to receive an input from a user which input includes the handwriting input into the input page, the method comprising:
displaying a new second input page on the display unit when an input for paging in a first direction, which is one of the forward and backward directions and in which no input page exists, is performed through the paging unit while a first or last page of a first input page in which a handwriting input is performed is displayed on the display unit;
not leaving the second input page and setting the first input page as a first or last input page when an input for paging in a second direction which is an opposite direction of the first direction is performed through the paging unit while no handwriting input is performed in the second input page displayed on the display unit; and
leaving the second input page in which a handwriting input is performed when the input for paging in the second direction is performed while the handwriting input is performed in the second input page displayed on the display unit.

14. The information processing method according to claim 13, wherein the second input page in which the handwriting input is performed is counted as one page.

15. The information processing method according to claim 14, wherein a total number of input pages is further displayed on the display unit, and
the total number of input pages displayed on the display unit is increased when the second input page in which the handwriting input is performed is counted as one page.

16. The information processing method according to claim 13, wherein a new input page is not displayed on the display unit even when the input for paging in the first direction is performed through the paging unit while the second input page in which no handwriting input is performed is displayed on the display unit.

17. The information processing method according to claim 13, wherein as control to display the second input page on the display unit, one of the following kinds of control is performed:
first control to display the second input page on the display unit when the input for paging in the first direction is performed only in a case where the first page of the first input page is displayed on the display unit;
second control to display the second input page on the display unit when the input for paging in the first direction is performed only in a case where the last page of the first input page is displayed on the display unit; and
third control to display the second input page on the display unit when the input for paging in the first direction is performed in both of the case where the first page of the first input page is displayed on the display unit and the case where the last page of the first input page is displayed thereon.

18. The information processing method according to claim 13, wherein in a case where there is a plurality of documents including the input page, the second input page is displayed on the display unit when the input for paging in the first direction is performed through the paging unit while a first input page in a document which is first in display order among the plurality of documents or a last input page in a document which is last in display order among the plurality of documents is displayed.
